(19) United States
(12) Patent Application Publication
(10) Pub. No.: US 2026/0365911 A1
(43) Pub. Date: Nov. 19, 2026

(54) ACRYLIC TERPOLYMERS WITH RANDOM SEQUENCES OF HIGHLY HYDROPHILIC MONOMERS TO DESTABILIZE EMULSIONS PRESENT IN CRUDE OILS

(71) Applicant: Instituto Mexicano del Petróleo, Mexico City (MX)

(72) Inventors: César Andrés Flores Sandoval, Mexico City (MX); Flavio Salvador Vázquez Moreno, Mexico City (MX); Gerardo Zavala Olivares, Mexico City (MX); Citlally Janinne Vargas Martínez, Mexico City (MX); Metzli Corona Estrada, Mexico City (MX); Héctor Alejandro Aranda Hernández, Mexico City (MX); Enrique Cevada Maya, Mexico City (MX)

(21) Appl. No.: 19/662,244

(22) Filed: Apr. 29, 2026

(30) Foreign Application Priority Data
Apr. 30, 2025 (MX) MX/A/2025/005099

(51) Int. Cl. C09K 8/588

(52) U.S. Cl. CPC C09K 8/588; C09K 2208/26

(57) ABSTRACT

The present disclosure relates to novel random terpolymers based on alkyl acetate-ethylene alkylacetate-β-carboxyalkyl acrylate to destabilize simple emulsion of the water-in-crude oil (W/O) type and/or complex emulsions of the crude oil-in-water-in-crude oil (O/W/O) type, in order to remove the emulsified water and dissolved salts in the latter; specifically, in direct applications in wells, offshore, and onshore units, for crude oils with gravities from 8 to 40° API.

### CROSS-REFERENCE TO RELATED APPLICATIONS

This patent application claims priority under 35 U.S.C. Section 119 to Mexican Patent Application No. MX/a/2025/005099, filed Apr. 30, 2025, the entire disclosure of which is incorporated herein by reference.

### FIELD

The present disclosure belongs to the field of chemical products for petroleum conditioning, in particular to that of demulsifying agents. More specifically, it relates to the application of random terpolymers based on alkyl acrylate-ethylene alkylacetate-β-carboxyalkyl acrylate to destabilize micrometric, submicrometric and/or nanometric emulsion of simple type, water-in-crude oil (W/O), or complex, crude oil-in-water-in-crude oil (O/W/O) present in crude oils with gravities ranging from 8 to 40° API, and therefore, to remove the emulsified water and the dissolved salts in the latter. Its application is mainly focused on onshore units, prior to the refining process, on offshore units, three-phase separators, and in wells, to prevent formation damage.

### BACKGROUND OF THE DISCLOSURE

During the extraction of crude oil, the presence of water in the form of an emulsion is inevitable, as well as the presence of salt, which is dissolved in the emulsified water and also dispersed in the crude oil as crystals. About the emulsions that are formed in crude oil, these are of the water-in-crude oil (W/O, known as simple emulsion) or crude oil-in-water-in-crude oil (O/W/O, known as complex emulsion) types. One of the factors that favors the emulsion stability is the droplet water size; this can be at micrometric, submicrometric and/or nanometric scale. Emulsion becomes more stable as the droplet water size decreases—micrometric<submicrometric<nanometric. In addition to this factor, it is known that emulsified water droplets are highly stabilized by the formation of solvated asphaltene fragments with resin fragments (called asphaltene-resin agglomerates) [1]. These agglomerates are adsorbed at the water droplet interface, forming a highly rigid structure that stalls the water droplet coalescence process. Doubtless, in heavy and extra-heavy crude oils—both with a high weight content of asphaltenes and resins fractions, the layer of asphaltene-resin agglomerates will be thicker, therefore, the emulsions present in these crude oils will be highly stables.

On the other hand, the presence of emulsified water in the well induces formation damage problems, causing a decrease in well production. During the extraction stage, an increase in the content of emulsified water and dispersed salts causes an increase in the viscosity of crude oil, significantly affecting its transport from the well to the refining stages (high demand on the pumping system, which equates to higher production cost). Besides, emulsified water and salts—dissolved and dispersed—severely affect pipes and equipment, generating corrosion and scale formation. Because of the aforementioned problems, it is imperative to eliminate or to reduce the emulsified water content to a maximum of 0.50 vol % and a maximum salt content of 50 lb·1000 bbls⁻¹—permissible values for crude oil of exportation.

For the treatment of crude oil, demulsifying agents are used to destabilize the asphaltene-resin agglomerates and to induce the coalescence of the emulsified water droplets. It is important for a demulsifying agent to possess the following three properties: breaker, coalescer and clarifier. At industrial level, there are three main families of demulsifying basics based on polyethers: (1) triblock bipolymers of ethylene oxide (EO)/propylene oxide (PO)—PEO-PPO-PEO, (2) ethoxylated phenolic resins (EPR), and (3) ethoxylated phenol nonyls (EPN). However, a single basic from any of these three families does not possess the required three properties in a demulsifying agent, hence, it is necessary to develop a formulation, considering at least three basics of different average molecular mass in number form the same family or combination between them, in order to obtain one demulsifying agent—formulation—with the required characteristics. It is important to point out that the demulsifying formulations based on polyethers exhibit several drawbacks: (1) the synthesis of PEO-PPO-PEO is carried out in two stages, both at high temperature and pressure, (2) the ethoxylation process of EPR and ENP is also carried out under high temperature and pressure conditions, (3) the cost of each basic presents an increase due to a shortage of ethylene oxide, (4) because of well acidic stimulations to increase production volume, if the pH of crude oil is from 4 to 6, the basics based on polyethers form micelles, which generates a barrier that stabilize the water droplets [2], and (5) continuing with the acid stimulation issue, if the pH of crude oil is from 0 to 3, the basics based on polyether suffer chemical degradation by the protonation of the ending hydroxyl group, which is eliminated in form of water-leaving group, forming an ending double bond [2], turning the molecule ineffective in inducing the destabilization of the water/crude oil interface. Due to the presence of the double bond in the polymer, it presents a strong interaction with the delocalized π system of the aromatic fragment of the asphaltenes, which provokes their precipitation.

A change in the functionality of the ending hydroxyl group in PEO-PPO-PEO triblock bipolymers (one for each PEO fragment) has been reported in the literature: (a) obtaining a fragment with an ending tertiary amine [3-6], (b) obtaining an ending alkylammonium salt fragment [4-7], and (c) formation of an ending amphoteric fragment [8-10]. These polymers with ending groups other than a hydroxyl group display excellent performance to remove emulsified water, superior to the PEO-PPO-PEO triblock bipolymers. Nevertheless, they exhibit the only drawback of requiring one or two additional synthesis steps; therefore, their use should be evaluated based on a performance/cost study (which is always favorable due to the drawbacks presented by the PEO-PPO-PEO triblock bipolymers).

On the other hand, about the use of dehydrating agents with a different chemistry than polyethers, acrylic-based polymers have been reported by different research groups. Ali et al. describes the microscale synthesis of Janus magnetic submicron particles—poly(methyl methacrylate-acrylic acid-divinylbenzene)/iron oxide (P(MMA-AA-DVB)/Fe₃O₄), as well as their demulsifying capacity [11]. The high interfacial activity and hydrophilic nature of Janus magnetic submicrometric particles, P(MMA-AA-DVB)/Fe₃O₄, allow them to be more effective in adsorption onto emulsified water droplets, thereby destabilizing this system. Jiang et al. evaluated a demulsifying nano-P (MMA-AA-EA) copolymer. This copolymer was synthesized by emulsion polymerization using divinylbenzene (DVB) as crosslinking agent and ammonium persulfate (APS) as an initiator [12]. The copolymer reached a maximum efficiency of 86%—at 60 min of assessment—at a temperature of 70 °C and a dosage of 400 ppm.

On another note, the use of random acrylic bipolymers—two hydrophobic monomers with different partition coefficients (Log P) [13, 14] and terpolymers—three hydrophobic monomers with different Log P [15, 16]—as antifoaming agents for gasified crude oil has been described in the literature. For the dehydration of emulsified crude oil, the synthesis and evaluation of random acrylic bipolymers have been described: (a) based on two hydrophobic monomers with different Log P [17] and (b) based on one hydrophobic monomer (higher Log P value) and one hydrophilic monomer (lower Log P value), the latter monomer is included in order to increase the hydrophilic centers in the acrylic bipolymer molecule, which are the ones that induce, in a more efficient way, the destabilization of the asphaltene-resin agglomerates layer [18-21, 22-25, 26, 27, 28-30].

Regarding random acrylic terpolymers, the works of Vargas-Martínez [31, 32], Zamora-Guerrero [33, 34], and Gómez-Buendía mention the use of random acrylic terpolymers for emulsified water removal in crude oils of different API gravity. It is important to point out that, in no work are described the chemical structures or proportions of the employed monomers for the synthesis of acrylic terpolymers, therefore, it is impossible to infer these. About the work of Gómez-Buendía, the random acrylic terpolymers showed a low performance in the removal of water.

By another way, Table 1 lists different random terpolymers based on one hydrophobic monomer and two hydrophilic monomers with different Log P value. The presence of two hydrophilic monomers gives to the random terpolymer a different chemical and electronic environment compared to acrylic bipolymers, capable of efficiently affecting the layer of asphaltene-resin agglomerates presents in simple and complex emulsions, and, hence, inducing the coalescence of the emulsified water droplets. The monomers that make up the terpolymers described in Table 1 have the following characteristics: (1) different chemical structure; (2) different chemical properties, and (3) different values of the partition coefficient (Log P) and hydration energy (HE). Regarding the partition coefficient (Log P), this is the quotient between the concentrations of a pure substance in a biphasic mixture—formed by two immiscible solvents in equilibrium—: n-octanol (dividend) and water (divisor). A high Log P value means that the solute (in this case the demulsifying agent based on acrylic; in the case of the PEO-PPO-PEO triblock bipolymers depends largely on the weight ratio of the two monomers) is more soluble in the organic phase—higher diffusion in this phase due to its hydrophobicity; while a low or negative Log P value means that the solute is more soluble in the inorganic phase, i.e., more hydrophilic. The formula for determining Log P is present in equation 1:

$$Log {P}_{octanol / water} = log ( \frac{{[ solute ]}_{octanol}}{{[ solute ]}^{no - ionized in water}} ) \qquad Eq . 1$$

TABLE 1
Random acrylic terpolymers reported in the literature
for the emulsified water removal of crude oils.

| | Acrylic monomers | | |
|---|---|---|---|
| Terpolymer | Hydrophobic | Hydrophilic | Reference |
| Alkyl acrylate - aminoalkyl | Butyl acrylate | 2-(Dimethylamino) ethyl acrylate | 36-38 |
| acrylate - carboxyalkyl | | 2-Carboxyethyl acrylate | |
| acrylate | | | |
| Alkyl acrylate - aminoalkyl | Butyl acrylate | 2-(Dimethylamino) ethyl acrylate | 39, 40 |
| acrylate -alkoxyalkyl | | Ethylene glycol methyl ether | |
| acrylate | | | |
| Alkyl acrylate - carboxyalkyl | Butyl acrylate | 2-Carboxyethyl acrylate | 41, 42 |
| acrylate - alkoxyalkyl | | Ethylene glycol methyl ether | |
| acrylate | | acrylate | |
| Alkyl acrylate- ethylene | Butyl acrylate | Ethylene alkanoate | 43 |
| alkanoate - alkoxyalkyl | | Ethylene glycol methyl ether | |
| acrylate | | acrylate | |
| Alkyl acrylate - vinylic - | Butyl acrylate | Vinyl 2-(Dimethylamino) ethyl | 44 |
| aminoalky acrylate | | acrylate | |

On the other hand, the hydration energy (HE) is the amount of energy released when a mole of ions is hydrated. Hydration energy is an important parameter in the quantitative analysis of solvation. A more negative value of HE means that a greater amount of energy is released due to greater hydration of the molecule—the negative polar fragment attracts the hydrogen atoms of water, while the positive polar fragment is attracted to the oxygen atom of water.

Thereby, both factors, Log P and HE, are utmost importance to design a novel dehydrating agent, thus: (1) it must have a partition coefficient that allows a favorable diffusion in crude oil (value greater than 1) and (2) it must contain a monomer with high hydration energy value (negative HE value), which will allow better interaction with the polar fragments of the asphaltene-resin agglomerates in order to induce their destabilization and to promote the coalescence of water droplets.

Table 2 lists the partition coefficient (Log P) and the hydration energy (HE) values for each of the monomers used in Table 1. Regarding Log P for hydrophilic monomers, ethylene alkanoate has the lowest Log P value, thus, it has high affinity for the hydrophilic phase of the system; whereas in the case of the HE values, 2-carboxyethyl acrylate is the most prone to form solvated ions by water molecules or by polar centers of another molecule—asphaltene-resin agglomerates. It is important to note that in the case of the 2-(dimethylamino)ethyl acrylate, despite containing a tertiary nitrogen atom—high susceptibility to protonation by the lone pair of electrons, the presence of the methyl groups, which generate a high steric hindrance, provokes that this monomer exhibits the lowest HE.

TABLE 2
Partition coefficient (Log P) and hydration energy
(HE) of employed acrylic monomers for the obtention
of random acrylic terpolymers reported in Table 1.

| | | HE |
|---|---|---|
| Monomer | Log P | (kcal/mol) |
| Butyl acrylate | 1.82 | 0.37 |
| 2-Ethylhexyl acetate | 3.42 | 1.72 |
| Vinyl acetate | −0.01 | −3.16 |
| 2-(Dimethyamino) ethyl | 0.60 | −0.29 |
| acrylate | | |
| Ethylene glycol methyl | 0.45 | −2.59 |
| ether acrylate | | |
| 2-Carboxyethyl acrylate | 0.34 | −6.38 |
| Acrylic acid | 0.58 | −6.04 |
| 2-Hydroxyethyl acrylate | 0.17 | −7.86 |

To random acrylic terpolymers that include in their structure a vinyl or ethylene alkanoate monomeric fragment, Table 3 lists the Log P and HE values for a theoretical structure considering four monomeric units: (a) two units of the hydrophobic monomer-alkyl acrylate, (b) one unit of the hydrophilic monomer-vinyl or ethylene alkanoate- and (c) one unit of the other hydrophilic monomer that constitutes the acrylic terpolymers described in references 43 and 44.

TABLE 3
Theoretical structure of a random acrylic terpolymer considering
four monomeric units: (a) two units of the hydrophobic monomer —alkyl
acrylate, (b) one unit of the hydrophilic monomer —vinyl or ethylene
alkanoate— and (c) one unit of another hydrophilic monomer.

| | | HE | |
|---|---|---|---|
| Terpolymer | Log P | (kcal · mol⁻¹) | Reference |
| Alkyl acrylate - ethylene | 2.99 | −2.15 | 43 |
| alkanoate - alkoxyalkyl | | | |
| acrylate | | | |
| Alky acrylate - vinylic - | 3.28 | −0.19 | 44 |
| aminoalkyl acrylate | | | |

### SUMMARY

This summary is intended to introduce the subject matter of the present disclosure, but does not cover each and every embodiment, combination, or variation that is contemplated and described within the present disclosure. Further embodiments are contemplated and described by the disclosure of the detailed description, drawings (if any), and claims.

In one aspect, the present disclosure relates to a random terpolymer comprising alkyl acrylate-ethylene alkylacetate-β-carboxyalkyl acrylate and useful as a demulsifying agent of crude oil with gravities from 8 to 40° API with different water content and composition in the SARA fractions up to 36 wt % of saturates, up to 35 wt % of aromatics, up to 20 wt % of resins, and up to 20 wt % of asphaltenes, wherein the random terpolymer comprises a structural Formula (1) with molecular masses between 1750 and 1100000 g·mol⁻¹:

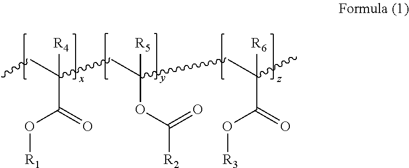

where:
   R₁, R₂, R₃, R₄, R₅, and R₆ are independent radicals represented by the groups mentioned below.
   R₁=CH₃ (methyl), C₂H₅ (ethyl), C₄H₉ (n-butyl), C₄H₉ (isobutyl), C₄H₉ (tert-butyl), C₅H₁₁ (pentyl), C₆H₁₃ (n-hexyl), C₈H₁₇ (2-ethylhexyl), C₉H₁₉ (3,5,5-trimethylhexyl), C₈H₁₇ (n-octyl), C₈H₁₇ (isooctyl), C₁₀H₂₁ (n-decyl), C₁₀H₂₁ (isodecyl), C₁₀H₁₉ (10-undecenyl), C₁₀H₁₉ (tert-butyl-cyclohexyl), C₁₂H₂₅ (n-dodecyl), C₁₈H₃₇ (n-octadecyl), C₁₃H₂₇ (tridecyl), or C₂₂H₄₅ (behenyl),
   R₂═CH₃ (methyl), C₂H₅ (ethyl), C₃H₇ (propyl), C₄H₉ (butyl), (CH₃)₃C (tert-butyl), C₈H₁₇ (octyl), C₉H₁₉ (nonyl), C₁₁H₂₃ (undecyl), or C₁₇H₃₅ (octadecanyl),
   R₃=C₃H₅₀₂ (2-carboxyethyl), C₄H₇₀₂ (3-carboxypropyl), or C₅H₉₀₂ (4-carboxybutyl),
   R₄ and R₆=H (hydrogen) or CH₃ (methyl),
   R₅=H, CH₃, or CN,
wherein:
   x=is a number set up from 9 to 1449,
   y=is a number set up from 3 to 994,
   z=is a number set up from 5 to 1307,
“x”, “y” and “z” are presented in a random sequences.

In one embodiment of the random terpolymer, the alkyl acrylate monomer is selected from the group consisting of: methyl acrylate, ethyl acrylate, butyl acrylate, pentyl acrylate, isobutyl acrylate, tert-butyl acrylate, hexyl acrylate, 2-ethylhexyl acrylate, 3,5,5-trimethylhexyl acrylate, 4-tert-butylcyclohexyl acrylate, octyl acrylate, isodecyl acrylate, decyl acrylate, lauryl acrylate, tridecyl acrylate, octadecyl acrylate, behenyl acrylate, methyl methacrylate, ethyl methacrylate, butyl methacrylate, pentyl methacrylate, isobutyl methacrylate, tert-butyl methacrylate, hexyl methacrylate, 2-ethylhexyl methacrylate, 3,5,5-trimethylhexyl methacrylate, 4-tert-butylcyclohexyl methacrylate, octyl methacrylate, isodecyl methacrylate, decyl methacrylate, lauryl methacrylate, tridecyl methacrylate, octadecyl methacrylate and behenyl methacrylate.

In one embodiment of the random terpolymer, the ethylene alkyl acetate monomer is selected from the group consisting of: vinyl acetate, vinyl propanoate, vinyl butyrate, vinyl trimethylacetate, vinyl pentanoate, vinyl laurate, vinyl neononanoate, vinyl decanoate, vinyl octadecanoate, 1-methylvinyl acetate, and 1-cyanovinyl acetate.

In one embodiment of the random terpolymer, the carboxyalkyl acrylate monomer is selected from the group consisting of: β-carboxyethyl acrylate, γ-carboxypropyl acrylate, δ-carboxybutyl acrylate, β-carboxyethyl methacrylate, γ-carboxypropyl methacrylate, and δ-carboxybutyl methacrylate.

In one embodiment of the random terpolymer, the ratio of the alkyl acrylate monomer is between 51.00 and 92.00 wt %, the ethylene alkylacetate monomer is in a compositional range from 3.00 to 35.00 wt %, and the β-carboxyalkyl acrylate monomer is in a range between 5.00 and 46.00 wt %.

In another aspect, the present disclosure relates to a formulation of a crude oil dehydrating agent, wherein the formulation comprises one or more random terpolymers as described herein formulated as dry random terpolymers dissolved in a dissolvent selected from the group consisting of: dichloromethane, methanol, ethanol, isopropanol, 2-butoxyethanol, 2-butoxyethane acetate, chloroform, benzene and its derivatives, toluene, xylene, turbosine, and naphtha, individually or in mixtures thereof.

In one embodiment of the formulation, the concentration of the formulation of the random terpolymers is from 0.50 to 50.00 wt %.

In one embodiment of the formulation, the formulation of the dissolved random terpolymers in a dissolvent is dosed to crude oil at a concentration in a range from 3 to 5000 ppm.

In another aspect, the present disclosure relates to a method of synthesizing one or more random terpolymer having a structural Formula (1) by semi-continuous emulsion polymerization.

In one embodiment of this method, the synthesis is performed under starved-monomeric feed conditions.

In one embodiment of this method, the synthesis is performed under conditions effective to ensure high randomness in the random terpolymer.

In one embodiment of this method, the alkyl acrylate monomer of the random terpolymer is selected from the group consisting of: methyl acrylate, ethyl acrylate, butyl acrylate, pentyl acrylate, isobutyl acrylate, tert-butyl acrylate, hexyl acrylate, 2-ethylhexyl acrylate, 3,5,5-trimethylhexyl acrylate, 4-tert-butylcyclohexyl acrylate, octyl acrylate, isodecyl acrylate, decyl acrylate, lauryl acrylate, tridecyl acrylate, octadecyl acrylate, behenyl acrylate, methyl methacrylate, ethyl methacrylate, butyl methacrylate, pentyl methacrylate, isobutyl methacrylate, tert-butyl methacrylate, hexyl methacrylate, 2-ethylhexyl methacrylate, 3,5,5-trimethylhexyl methacrylate, 4-tert-butylcyclohexyl methacrylate, octyl methacrylate, isodecyl methacrylate, decyl methacrylate, lauryl methacrylate, tridecyl methacrylate, octadecyl methacrylate, and behenyl methacrylate.

In one embodiment of this method, the ethylene alkyl acetate monomer of the random terpolymer is selected from the group consisting of: vinyl acetate, vinyl propanoate, vinyl butyrate, vinyl trimethylacetate, vinyl pentanoate, vinyl laurate, vinyl neononanoate, vinyl decanoate, vinyl octadecanoate, 1-methylvinyl acetate, and 1-cyanovinyl acetate.

In one embodiment of this method, the carboxyalkyl acrylate monomer of the random terpolymer is selected from the group consisting of: β-carboxyethyl acrylate, γ-carboxypropyl acrylate, δ-carboxybutyl acrylate, β-carboxyethyl methacrylate, γ-carboxypropyl methacrylate, and δ-carboxybutyl methacrylate.

In one embodiment of this method, the ratio of the alkyl acrylate monomer is between 51.00 and 92.00 wt %, the ethylene alkylacetate monomer is in a compositional range from 3.00 to 35.00 wt %, and the β-carboxyalkyl acrylate monomer is in a range between 5.00 and 46.00 wt %.

In another aspect, the present disclosure relates to a method of using a random terpolymer as described herein as a demulsifying agent of crude oil, the method comprising treating the crude oil with one or more of the random terpolymers.

In one embodiment of this method, the random terpolymers are used as demulsifying agents of crude oil for removal of simple emulsions of the water-in-crude oil (W/O) type and/or complex emulsions of the crude oil-in-water-in-crude oil (O/W/O) type.

In one embodiment of this method, the random terpolymers are formulated as dry random terpolymers dissolved in a dissolvent selected from the group consisting of: dichloromethane, methanol, ethanol, isopropanol, 2-butoxyethanol, 2-butoxyethane acetate, chloroform, benzene and its derivatives, toluene, xylene, turbosine, and naphtha, individually or in mixtures thereof.

In one embodiment of this method, the concentration of the formulation of the random terpolymers is from 0.50 to 50.00 wt %.

In one embodiment of this method, the formulation of the dissolved random terpolymers in a dissolvent is dosed to crude oil at a concentration in a range from 3 to 5000 ppm.

About the alkyl acrylate-ethylene alkylacetate-β-carboxyalkyl acrylate of the present disclosure, specifically for the theoretical structure of four monomeric fragments, it shows a Log P=2.88 and a HE=−8.12 values (higher than those present in Table 3). For this reason, taking into account that the random terpolymers based on alkyl acrylate-ethylene alkylacetate-β-carboxyalkyl acrylate display a high negative HE value, because of the combination of both hydrophilic monomers, but to a greater degree due to the presence of the β-carboxyalkyl acrylate monomer, it provides to the terpolymer specific fragments with high polarizability and ease to form ionic species. These polar fragments in the terpolymer interact with the polar fragments of the asphaltene-resin agglomerates, inducing their destabilization, and, thus, favoring the water droplets coalescence.

Finally, it is of utmost importance to highlight that a single basic of the random terpolymer based on alkyl acrylate-ethylene alkylacetate-β-carboxyalkyl acrylate present the three required characteristics in a demulsifying agent-breaker of water-in-crude oil emulsion and/or crude oil-in-water-in-crude oil emulsion, coalescer of the emulsified water droplets, and clarifier of separated aqueous phase, which avoids the preparation of a formulation of different basics. Using only one basic to fulfill the required characteristics of a demulsifying agent has a significant impact on the cost-benefit ratio, outperforming polyether-based commercial demulsifiers.

Therefore, the use of random terpolymers base alky acrylate-ethylene alkylacetate-β-carboxyalkyl acrylate has the following advantages over the current products based on polyethers:
Techniques: synthesis conditions (T<85 °C y P=atmospheric), use of a single basic, better performance in breaking the emulsion, better performance in removing water, high chemical stability, and non-toxic products.
Economical: lower cost due to the use of a single basic, single-stage synthesis process, and lower cost in the evaporation of the reaction medium (water, temperature no higher than 120 °C).

Based on the above, one of the aims of the present disclosure is to provide novel random terpolymers based on alkyl acrylate (K)-ethylene alkylacetate (N)-β-carboxyalkyl acrylate (X). Another aim of the present disclosure is based on the synthesis of these acrylic terpolymers by means of the emulsion polymerization process in a semi-continuous reactor. During the synthesis process, the starved-monomeric feed condition is established to ensure a high randomness in the terpolymer. The synthesis procedure has been developed at the Mexican Petroleum Institute, which is detailed in the patent documents MX 38360 [13], U.S. Pat. No. 10,221,349 [14], MX 401423 [15], U.S. Pat. No. 10,982,031 [16], MX 386485 [18], U.S. Pat. No. 10,975,185 [19], CA 2,987.447 C [20], MX 410469 [22], U.S. Pat. No. 10,793,783 [23], CA 3,013,494 C [24], U.S. Pat. No. 11,692,144 [29], U.S. Pat. No. 11,920,092 [30], MX 38861 [45], U.S. Pat. No. 9,120,885 [46], MX 378417 [47], and U.S. Pat. No. 10,213,708 [48]. The final conversion of K, N, and X monomers must be between 98.5% and 100% and with a solid ratio (S.T.) from 19.7 to 20.0 wt %.

Furthermore, another additional aim of the present disclosure focuses on the application of random terpolymers based on alkyl acrylate-ethylene alkylacetate-β-carboxyalkyl acrylate as demulsifying agents is to destabilize W/O and/or O/W/O emulsions present in crude oils with gravities from 8 to 40° API. These exhibit high performance in destabilization of the asphaltene-resin agglomerates layer, inducing emulsion breaking within the range from 5 to 15 min of the assessment time, significantly outperforming commercial products based on polyethers.

In certain embodiments, to obtain the demulsifying agents based on alkyl acetate-ethylene alkylacetate-β-carboxyalkyl acrylate, the following were initially considered: (a) a hydrophobic acrylic monomer (alkyl acrylate) and (b) two hydrophilic monomers (ethylene alkylacetate and β-carboxyalkyl acrylate). The selection of the three monomers was based on parameters such as the partition coefficient (Log P) and the hydration energy (HE). In this case, the hydrophilic monomers provide to the random acrylic polymer a high negative HE values, due to the random polar fragments that efficiently interact with the polar centers of the asphaltene-resin agglomerates, efficiently inducing the destabilization of the agglomerates. Specifically, a higher weight ratio of the β-carboxyalkyl monomer induces a greater efficiency in destabilization of the water/crude oil interface, as well as an increase in the coalescence rate of water droplets and excellent clarification of the removed water, significantly outperforming commercial formulations. Finally, the molecular weight of the random acrylic terpolymer plays an important role in crude oil dehydration: a light crude oil requires a random acrylic terpolymer of low molecular mass, whereas an extra-heavy crude oil requires a random acrylic terpolymer of high molecular mass.

The foregoing and other objectives of the present disclosure will be set forth more clearly and in detail in the following disclosure.

### REFERENCES

[1] P. M. Spiecker, K. L. Gawrys, P. K. Kilpatrick. Aggregation and solubility behavior of asphaltenes and their subfractions. J. Colloid. Interface Sci. 267 (2003) 178-193.
[2] B. Yang, C. Guo, S. Chen, J. Ma, J. Wang, X. Liang, L. Zheng, H. Liu. Effect of acid on the aggregation of poly(ethylene oxide)-poly(propylene oxide)-poly(ethylene oxide) block copolymers. J. Phys. Chem. B 110 (2006) 23068-23074.
[3] G. Cendejas-Santana, E. A. Flores-Oropeza, L. V. Castro-Sotelo, A. Estrada-Buendía, M. Lozada-y-Cassou, F. S. Vázquez-Moreno. Demulsifying and dehydrating formulations for heavy crude oils based on block copolymers bifunctionalized with amines. American patent U.S. Pat. No. 8,815,960. Aug. 26, 2014.
[4] C. A Flores-Sandoval, E. A. Flores-Oropeza, J. G. Hernández-Cortez, A. Estrada-Buendía, L. V. Castro-Sotelo, R. Reyes-Martínez, F. Álvarez-Ramírez, A. Estrada-Martínez, F. S. Vázquez-Moreno. Mexican patent MX 368308. Sep. 26, 2019.
[5] C. A. Flores-Sandoval, E. A. Flores-Oropeza, A. López Ortega, J. G. Hernández Cortez, A. Estrada-Buendía, L. V. Castro-Sotelo, R. Reyes Martínez, F. Álvarez Ramírez, A. Estrada Martínez, F. S. Vázquez-Moreno. Scale-up process of bifunctionalized triblock copolymers with secondary and tertiary amines, with application in dewatering and desalting of heavy crude oils. Canadian patent CA 2 852 863 C. Nov. 8, 2016.
[6] C. A. Flores-Sandoval, E. A. Flores-Oropeza, A. López Ortega, J. G. Hernández Cortez, A. Estrada-Buendía, L. V. Castro-Sotelo, R. Reyes Martínez, F. Álvarez Ramírez, A. Estrada Martínez, F. S. Vázquez-Moreno. Scale-up process of bifunctionalized triblock copolymers with secondary and tertiary amines, with application in dewatering and desalting of heavy crude oils. American patent U.S. Pat. No. 10,125,226. Nov. 13, 2018.
[7] E. B. Zamora, F. Vázquez, E. I. Hernández, F. Álvarez, G. Zavala, A. López, C. A. Flores-Sandoval. Triblock copolymers functionalized with quaternary ammonium salts as dehydrating agents for heavy and extra-heavy crude oils. J. Disper. Sci. Technol. 39 (2018) 1502-1509.
[8] J. V. Fuentes-Santiago, E. B. Zamora-Guerrero, F. Álvarez-Ramírez, G. Zavala-Olivares, A. López-Ortega, F. S. Vázquez-Moreno, C. A. Flores-Sandoval. Bipolímeros tribloques POE-POP-POE, con terminaciones anfotéricas, como agentes desemulsionantes de aceites crudos pesados. Mexican patent application MX/a/2019/005132. May 2, 2019.
[9] C. A. Flores-Sandoval, F. S. Vázquez-Moreno, A. López-Ortega, F. Álvarez-Ramírez, G. Zavala-Olivares, J. V. Fuentes-Santiago, E. B. Zamora-Guerrero. PEO-PPO-PEO triblock bipolymers, with amphoteric endings, as demulsifying agents for heavy crude oils. American patent U.S. Pat. No. 11,261,282. Mar. 1, 2022.
[10] J. V. Fuentes, E. B. Zamora, R. Mariath, Z. Li, X. Zhenghe, F. Vázquez, C. A. Flores, Dehydrating heavy crude oils with new amphoteric block bipolymers. Ener. Fuel. 2020, 34, 4307-4317.
[11] N. Ali, B. Zhang, H. Zhang, W. Li, W. Zaman, L. Tian, Q. Zhang. Novel Janus magnetic micro particle synthesis and its applications as a demulsifier for breaking heavy crude oil and water emulsion. Fuel 141 (2015) 258-267.
[12] X. Jiang, Z. Huang, Y. Mi, J. Kuang, F. Ye. Emulsion polymerization of P(MMA-AA-EA) and its demulsifying performance in water/oil emulsion. Open J. Yangtze GasOil 4 (2019) 212-224.
[13] E. I. Hernández-Carbajal, E. Cevada-Maya, A. López-Ortea, C. A. Flores-Sandoval, F. Álvarez-Ramírez, A. Estrada-Martínez, F. S. Vázquez-Moreno. Formulaciones de copolímeros base acrilatos de alquilo empleados como antiespumantes en aceites crudos pesados y superpesados. Mexican patent MX 383630. Jun. 8, 2021.
[14] E. I. Hernández-Carbajal, E. Cevada-Maya, A. López-Ortea, C. A. Flores-Sandoval, F. Álvarez-Ramírez, A. Estrada-Martínez, F. S. Vázquez-Moreno. Formulations of copolymers based on alkyl acrylates used as defoamers of heavy and super-heavy crude oil. American patent U.S. Pat. No. 10,221,349. Mar. 5, 2019.
[15] E. I. Hernández-Carbajal, A. López-Ortega, C. A. Flores-Sandoval, F. Álvarez-Ramírez, J. C. Clavel-López, F. S: Vázquez-Moreno, E. Cevada-Maya. Formulaciones de terpolímeros base acrilatos de alquilo empleadas como antiespumantes en aceites crudos gasificados pesados y superpesados. Mexican patent MX 401423. Mar. 24, 2023.
[16] E. I. Hernández-Carbajal, A. López-Ortega, C. A. Flores-Sandoval, F. Álvarez-Ramírez, J. C. Clavel-López, F. S: Vázquez-Moreno, E. Cevada-Maya. Formulation of terpolymers based on alkyl acrylates employed as antifoaming of gasified heavy and super-heavy crude oils. American patent U.S. Pat. No. 10,982,031. Apr. 20, 2021.
[17] E. Cevada, N. Palacios, E. Hernández, L. Castro, A. López, C. Flores, F. Álvarez, F. Vázquez. Novel petroleum demulsifiers based on acrylic random copolymers. J. Disper. Sci. Technol. 40 (2019) 495-506. https://doi.org/10.1080/01932691.2018.1472009.
[18] E. I. Hernández-Carbajal, C. A. Flores-Sandoval, F. Álvarez-Ramírez, A. López-Ortega, R. J. García-Jiménez, G. Zavala-Olivares. Desemulsionantes para aceites crudos con base en copolímeros aleatorios acrílico-aminoacrílico de masa molecular controlada. Mexican patent MX 386485. Sep. 15, 2021.
[19] E. I. Hernández-Carbajal, C. A. Flores-Sandoval, F. Álvarez-Ramirez, A. López-Ortega, R. J. García-Jiménez, G. Zavala-Olivares, J. C. Clavel-López, F. S. Vázquez-Moreno. Demulsifiers for crude oil based on acrylic-aminoacrylic random copolymers of controlled molecular mass. American patent U.S. Pat. No. 10,975,185 B2. Apr. 13, 2021.
[20] E. I. Hernández-Carbajal, C. A. Flores-Sandoval, F. Álvarez-Ramirez, A. López-Ortega, R. J. García-Jiménez, G. Zavala-Olivares, J. C. Clavel-López, F. S. Vázquez-Moreno. Demulsifiers for crude oil based on acrylic-aminoacrylic random copolymers of controlled molecular mass. Canadian patent CA 2 987 447 C. Aug. 10, 2021.
[21] E. B. Zamora, E. I. Hernández, G. Zavala, J. V. Fuentes, F. Álvarez, C. A. Flores, Flavio Vázquez. High performance demulsifiers for heavy crude oil based on alkyl acrylic-amino alkyl acrylic random bipolymers. Sep. Purif. Technol. 275 (2021) 119212.
[22] C. A. Flores-Sandoval, M. A. Chávez-Mora, E. B. Zamora-Guerrero, A. López-Ortega, G. Zavala-Olivares, F. Álvarez-Ramírez, F. S. Vázquez-Moreno. Removedores de emulsiones agua/aceite crudo con base en copolímeros aleatorios alquilacrílico-carboxialquilacrílico de masa molecular controlada. Mexican patent MX 410469. Feb. 8, 2024.
[22] C. A. Flores-Sandoval, M. A. Chávez-Mora, E. B. Zamora-Guerrero, A. López-Ortega., G. Zavala-Olivares, F. Álvarez-Ramírez, F. S. Vázquez-Moreno. Water/crude oil removers based on alkylacrylic-carboxyalkylacrylic random copolymers of controlled molecular mass. American patent U.S. Pat. No. 10,793,783. Oct. 6, 2020.
[23] C. A. Flores-Sandoval, M. A. Chávez-Mora, E. B. Zamora-Guerrero, A. López-Ortega., G. Zavala-Olivares, F. Álvarez-Ramírez, F. S. Vázquez-Moreno. Water/crude oil removers based on alkylacrylic-carboxyalkylacrylic random copolymers of controlled molecular mass. Canadian patent CA 3 013 494 C. Dec. 8, 2020.
[25] J. V. Fuentes, E. B. Zamora, Z. Li, Z. Xu, A. Chakraborty, G. Zavala, F. Vázquez, C. Flores. Alkylacrylic-carboxyalkylacrylic random bipolymers as demulsifiers for heavy crude oils. Sep. Purif. Technol. 256 (2021) 117850.
[26] C. A. Flores-Sandoval, F. S. Vázquez-Moreno, G. Zavala-Olivares, J. V. Fuentes-Santiago, E. B. Zamora-Guerrero, E. Cevada-Maya. Remoción de emulsiones agua-en-aceite crudo empleando macromoléculas de acrilatos hidrofóbicos e hidrofílicos. Mexican patent application MX/a/2021/008781. Jul. 21, 2021.
[27] C. A. Flores-Sandoval, F. S. Vázquez-Moreno, G. Zavala-Olivares, F. Álvarez-Ramírez, J. V. Fuentes-Santiago, E. B. Zamora-Guerrero, E. Cevada-Maya. Bipolímeros aleatorios de masa molecular controlada, base hidroxiacrílicos empleados como desestabilizadores de emulsiones agua/aceite, presentes en aceites crudos. Mexican patent application MX/a/2022/005169. Apr. 28, 2022.
[28] C. J. Vargas-Martínez, C. A. Flores-Sandoval, E. B. Zamora-Guerrero, E. Cevada-Maya, E. Gómez-Buendía, F. Álvarez-Ramírez, F. S. Vázquez-Moreno, G. Zavala-Olivares, Jessica V. Fuentes-Santiago. Bipolímeros de adición con alta aleatoridad para desestabilización de emulsiones complejas en mezclas de aceites crudos. Mexican patent application MX/a/2020/011505. Oct. 29, 2020.
[29] C. A. Flores-Sandoval, F. S. Vázquez-Moreno, F. Álvarez-Ramírez, G. Zavala-Olivares, E. Gómez-Buendia, E. Cevada-Maya, J. V. Fuentes-Santiago, E. B. Zamora-Guerrero, C. J. Vargas-Martinez. Highly random addition bipolymers for destabilization of complex emulsions in crude oil blends. American patent U.S. Pat. No. 11,692,144. Jul. 4, 2023.
[36] C. A. Flores-Sandoval, F. S. Vázquez-Moreno, F. Álvarez-Ramírez, G. Zavala-Olivares, E. Gómez-Buendía, E. Cevada-Maya, J. V. Fuentes-Santiago, E. B. Zamora-Guerrero, C. J. Vargas-Martinez. Highly random addition bipolymers for destabilization of complex emulsions in crude oil blends. American patent U.S. Pat. No. 11,920,092. Mar. 5, 2024.
[31] C. J. Vargas-Martínez. Chemical Engineering thesis, Universidad Veracruzana (UV). Facultad de Ciencias Químicas. Síntesis y evaluación de terpolímeros acrílicos aleatorios para el deshidratado de aceites crudos extra-pesados. Págs. 39-43. January 2018.
[32] C. J. Vargas-Martínez. Master's in science thesis. Instituto Mexicano del Petróleo (IMP). Evaluación del desempeño de nuevos agentes desemulsionantes base acrílico en aceites crudos mexicanos: sistema estático versus fuerza inducida. Págs. 48-51. June 2020.
[33] E. B. Zamora-Guerrero. Master's in science thesis. Instituto Mexicano del Petróleo (IMP). Síntesis, caracterización y evaluación como agentes deshidratantes de petróleo de copolímeros y terpolímeros acrílicos. Págs. 82-86. August 2018.
[34] E. B. Zamora-Guerrero. PhD tesis in engineering, Instituto Mexicano del Petróleo (IMP). Deshidratación y desalado de aceites crudos: relación estructura-actividad. Págs. 43-49. August 2022.
[35] E. Gómez-Buendia. PhD tesis in engineering, Instituto Mexicano del Petróleo (IMP). Desestabilización de emulsiones complejas agua/petróleo inducida por polímeros surfactantes. Págs. 192-214. August 2022.
[36] C. J. Vargas-Martínez, C. A. Flores-Sandoval, E. B. Zamora-Guerrero, F. Álvarez-Ramírez, F. S. Vázquez-Moreno, G. Zavala-Olivares, J. V. Fuentes-Santiago. Desemulsionantes para aceite crudo con base en terpolímeros aleatorios alquilacrílico-aminoacrílico-carboxiacrílico de masa molecular controlada. Mexican patent application MX/a/2020/002212. Feb. 27, 2020.
[37] C. A. Flores-Sandoval, F. S. Vázquez-Moreno, F. Álvarez-Ramírez, G. Zavala-Olivares, J. V. Fuentes-Santiago, E. B. Zamora-Guerrero, C. J. Vargas-Martínez. Demulsifying agents for crude oil based on random alkylacrylic-aminoalkylacrylic-carboxyalkylacrylic terpolymers of controlled molecular mass. American patent application US20210277314 A1. Sep. 9, 2021.
[38] J. V. Fuentes, E. B. Zamora, A. Chakraborty, G. Zavala, Z. Xu, W. McCaffrey, Z. Li, F. Vázquez, C. A. Flores. A critical evaluation of novel demulsifying agents based on acrylic terpolymers for Mexican heavy crude oils dehydration. Sep. Purif. Technol. 281 (2022) 119878.
[39] C. J. Vargas-Martínez, C. A. Flores-Sandoval, E. B. Zamora-Guerrero, E. Cevada-Maya, E. Gómez-Buendía, F. Álvarez-Ramírez, F. S. Vázquez-Moreno, G. Zavala-Olivares, J. V Fuentes-Santiago. Nuevas macromoléculas alquiladas, aminadas y alcoxiladas con propiedades trifuncionales integradas para la remoción de emulsiones de petróleo. Mexican patent application MX/a/2020/010501. Oct. 5, 2020.
[40] C. A. Flores-Sandoval, F. S. Vázquez-Moreno, F. Álvarez-Ramírez, G. Zavala-Olivares, C. J.-Vargas Martínez, J. V. Fuentes-Santiago, E. B. Zamora-Guerrero, E. Cevada-Maya, E. Gómez-Buendia. Novel alkylated, aminated and alkoxylated macromolecules with integrated trifunctional properties for the removal of petroleum emulsions. American patent application US20220106530 A1. Apr. 7, 2022.
[41] C. A. Flores-Sandoval, F. S. Vázquez-Moreno, G. Zavala-Olivares, F. Álvarez-Ramírez, E. B. Zamora-Guerrero, J. V. Fuentes-Santiago, C. J. Vargas-Martínez, G. N Rodríguez-Araujo, E. Cevada-Maya. Terpolímeros acrílicos aleatorios de masa molecular controlada empleados como desestabilizadores de agua en aceite crudo. Mexican patent application MX/a/2022/008218. Jun. 30, 2022.
[42] C. A. Flores-Sandoval, F. S. Vázquez-Moreno, G. Zavala-Olivares, F. Álvarez-Ramírez, E. B. Zamora-Guerrero, J. V. Fuentes-Santiago, C. J. Vargas-Martínez, G. N. Rodríguez-Araujo, E. Cevada-Maya. Random acrylic terpolymers of controlled molecular mass useful as water in crude oil emulsions destabilizers. American patent application US20240002736. Jan. 4, 2024.
[43] C. A. Flores-Sandoval, F. S. Vázquez-Moreno, P. Pérez-Romo, G. Zavala-Olivares, C. J. Vargas-Martínez, G. N. Rodríguez-Araujo, G. L. Manobanda-Navas, M. Corona-Estrada, C. D. Rodríguez-Araujo, H. A. Aranda-Hernández, E. Cevada-Maya. Terpolímeros acrílicos aleatorios de masa molecular controlada empleados en la desestabilización de emulsiones simples (W/O) y/o complejas (O/W/O) en aceites crudos. Mexican patent application MX/a/2023/009450. Aug. 11, 2023.
[44] F. S. Vázquez-Moreno, C. A. Flores-Sandoval, P. Pérez-Romo, G. Zavala-Olivares, E. López-Salinas, G. N. Rodríguez-Araujo, C. J. Vargas-Martínez, G. L. Manobanda-Navas, M. Corona-Estrada, C. D. Rodríguez-Araujo, H. A. Aranda-Hernández, E. Cevada-Maya, Removedores de emulsiones agua/aceite crudo con base en terpolímeros anfifílicos con secuencias aleatorias de alquil acrílico-vinílico-aminoalquil acrílico. Mexican patent application MX/a/2024/004088. Apr. 2, 2024
[45] M. Lozada-y-Cassou, E. A. Flores-Oropeza, G. Cendejas-Santana, L. V. Castro-Sotelo, F. S. Vázquez-Moreno. Formulación de polímeros aleatorios para mejorar flujo de crudos del petróleo. Mexican patent MX 338861. Apr. 28, 2016.
[46] L. V. Castro-Sotelo, E. A. Flores-Oropeza, G. Cendejas Santana, M. Lozada-y-Cassou, F. S. Vázquez Moreno. Formulations of random polymers for improving crude petroleum flow. American patent U.S. Pat. No. 9,120,885. Sep. 1, 2015,
[47] E. Cevada-Maya, L. V. Castro-Sotelo, E. I. Hernández-Carbajal, C. A. Flores-Sandoval, A. López-Ortega, A. Estrada-Buendía, F. Álvarez-Ramírez, A. Estrada-Martínez, F. S. Vázquez-Moreno. Formulaciones de homopolímeros base acrilatos de alquilo empleadas como antiespumantes en aceites crudos pesados y súper pesados. Mexican patent MX 378417. Dec. 14, 2020.
[48] E. Cevada-Maya, L. V. Castro-Sotelo, E. I. Hernández-Carbajal, C. A. Flores-Sandoval, A. López-Ortega, A. Estrada-Buendía, F. Álvarez-Ramírez, A. Estrada-Martínez, F. S. Vázquez-Moreno. Formulations of homopolymers based on alkyl acrylates as antifoaming agents in heavy and super-heavy crude oils. American patent U.S. Pat. No. 10,213,708. Feb. 26, 2019.
[49] G. Cendejas, F. Arreguín, L. V. Castro, E. A. Flores, F. Vazquez. Demulsifying super-heavy crude oil with bifunctionalized block copolymers. Fuel 103 (2013) 356-363.

### BRIEF DESCRIPTION OF THE DRAWINGS

In order to provide clarity in the description of the random acrylic terpolymers based on alkyl acrylate-ethylene alkylacetate-β-carboxyalkyl acrylate of controlled molecular mass, their production process, as well as their performance in the destabilization of simple and/or complex emulsions in crude oils, and, objects of the present disclosure, it will be referenced to the drawings, without limiting the scope of the present disclosure.

FIG. 1 shows the efficiency in the emulsified water removal using the random terpolymers based on alkyl acrylate-ethylene alkylacetate-β-carboxyalkyl acrylate of the KNX-2 series, with different monomeric weight composition, the TOMAC ionic liquid, as well as the FD-1, FD-2, FD-3, and FD-4 commercial formulations, which were evaluated in the PR-1 crude oil (14.50° API) at a dosage of 1000 ppm.

FIG. 2 displays the images of the optical micrographs and bottles of the PR-1 crude oil (14.50° API) after having been treated with the KNX-6132—100 vol %, 25 min—, KNX-6222—100 vol %, 60 min—, KNX-7122—100 vol %, 90 min—, KNX-7212—100 vol %, 120 min—, and KNX-6312—100 vol %, 180 min—random terpolymers based on alkyl acrylate-ethylene alkylacetate-β-carboxyalkyl acrylate at a dosage of 1000 ppm.

FIG. 3 exhibits the efficiency in the emulsified water removal employing the random terpolymers based on alkyl acrylate-ethylene alkylacetate-β-carboxyalkyl acrylate of different monomeric composition of the KNX-4 series, the TOMAC ionic liquid, as well as the FD-1, FD-2, FD-3, and FD-4 commercial formulations, which were assessed in the PR-1 crude oil (14.50° API) at a dosage of 1000 ppm.

FIG. 4 displays the images of the optical micrographs and bottles corresponding to the PR-1 crude oil (14.50° API), after having been treated with the random terpolymers based on alkyl acrylate-ethylene alkylacetate-β-carboxyalkyl acrylate KNX-6314—100 vol %, 40 min—, KNX-6224—100 vol %, 120 min—, KNX-7124—100 vol %, 180 min—KNX-7214—100 vol %, 240 min—, and KNX-6314—95 vol %, 90 min—.

FIG. 5 presents the efficiency in the emulsified water removal employing the random terpolymers based on alkyl acrylate-ethylene alkylacetate-β-carboxyalkyl acrylate with different monomeric composition of the KNX-2 series, the TOMAC ionic liquid, as well as the FD-1, FD-2, FD-3, and FD-4 commercial formulations, which were assessed in the PR-2 crude oil (21.60° API) at a dosage of 1000 ppm.

FIG. 6 shows the images of the optical micrographs and bottles corresponding to the PR-2 crude oil (21.60° API), after having been treated with the KNX-6132—100 vol %, 180 min— and KNX-622—87 vol %, 180 min-random terpolymers based on alkyl acrylate-ethylene alkylacetate-β-carboxyalkyl acrylate, as well as the FD-3 commercial formulation-40 vol %, 90 min—, at a dosage of 1000 μm.

FIG. 7 presents the efficiencies in the emulsified water removal employing the random terpolymers based on alkyl acrylate-ethylene alkylacetate-β-carboxyalkyl acrylate of the KNX-4 series, the TOMAC ionic liquid, as well as, the FD-1, FD-2, FD-3, and FD-4 commercial formulations, all of them evaluated in the PR-2 crude oil (21.60° API) at a dosage of 1000 ppm.

FIG. 8 exhibits the images of the optical micrographs and bottles of the PR-3 crude oil (21.60° API), after having been treated with the KNX-6134—100 vol %, 50 min—, KNX-622—100 vol %, 90 min—, and KNX-7124—93 vol %, 120 min—random terpolymers based on alkyl acrylate-ethylene alkylacetate-β-carboxyalkyl acrylate at a dosage of 1000 ppm.

FIG. 9 describes the efficiencies in the emulsified water removal using the random terpolymers based on alkyl acrylate-ethylene alkylacetate-β-carboxyalkyl acrylate of the KNX-4 series, the TOMAC ionic liquid, as well as the FD-1, FD-2, FD-3, and FD-4 commercial formulations, all of them assessed in the PR-3 crude oil (28.70° API) at a dosage of 1000 ppm.

FIG. 10 displays the images of the optical micrographs and bottles of the PR-3 crude oil (28.70° API), after having been treated with the KNX-6134—100 vol %, 25 min—, KNX-6224—100 vol %, 40 min—, and KNX-7124—100 vol %, 50 min—random terpolymers based on alkyl acrylate-ethylene alkylacetate-β-carboxyalkyl acrylate, as well as, the TOMAC ionic liquid—75 vol %, 240 min—, at a dosage of 1000 ppm.

### DETAILED DESCRIPTION

The present disclosure relates to novel acrylic terpolymers based on alkyl acrylate-ethylene alkylacetate-β-carboxyalkyl acrylate, synthesis process for their production and their use as demulsifying agents of crude oil, specifically for the removal of simple emulsions of the water-in-crude oil (W/O) type and/or complex emulsions of the crude oil-in-water-in-crude oil (O/W/O) type.

The novel random terpolymers based on alkyl acrylate-ethylene alkylacetate-β-carboxyalkyl acrylate were synthesized in latex form by emulsion polymerization in a semi-continuous process, always keeping starved-monomeric feed conditions, which ensures a high randomness of the synthesized polymer. The synthesis procedure is widely described in the patent documents MX 38360 [13], U.S. Pat. No. 10,221,349 [14], MX 401423 [15], U.S. Pat. No. 10,982,031 [16], MX 386485 [18], U.S. Pat. No. 10,975,185 [19], CA 2,987,447 C [20], MX 410469 [22], U.S. Pat. No. 10,793,783 [23], CA 3,013,494 C [24], U.S. Pat. No. 11,692,144 [29], U.S. Pat. No. 11,920,092 [30], MX 38861 [45], U.S. Pat. No. 9,120,885 [46], MX 378417 [47], and U.S. Pat. No. 10,213,708 [48]. Monomers are found in the following proportions:
Alkyl acrylate (K): between 51.00 and 92.00 wt %.
Ethylene alkylacetate (N): between 3.00 and 35.00 wt %.
β-carboxyalkyl acrylate (X): between 5.00 and 46.00 wt %.

It is important to mention that the alkyl acrylate monomer (K) must always be present in a greater proportion than the N and X hydrophilic monomers, this is because, as was described above, the K monomer, due to its partition coefficient, allows better diffusion in the organic phase (crude oil). Furthermore, once the evaluation of the water removal performance is complete, the KNX terpolymers remain in the organic phase, which will decompose into water vapor, aldehydes, and carbon dioxide in crude oil refining units.

Returning to the synthesis process, once the latex of the KNX random acrylic terpolymer has been obtained, this is subjected to an evaporation process—in order to eliminate the employed water in the synthesis—at temperature between 80 and 120 °C (higher temperatures could cause the knotting of the terpolymer), to finally obtain a viscous liquid, with water content between 0.10 and 5.00 vol %. Afterwards, the dry random acrylic terpolymer is dissolved in a suitable organic solvent such as dichloromethane, methanol, ethanol, isopropanol, 2-butoxyethanol, 2-butoxyethane acetate, chloroform, benzene and its derivatives, toluene, xylene, turbosine, and naphtha, individually or as mixture, for its final application as a demulsifying agent in crude oils with a gravities from 8 to 40° API. The concentration of the random acrylic terpolymer in solution can vary from 0.50 to 50.00 wt %, while the formulations are dosed at a concentration in a range from 3 to 5000 ppm.

Structure (1) represents the formula of the random terpolymers based on alkyl acrylate-ethylene alkylacetate-β-carboxyalkyl acrylate, included in the present disclosure:

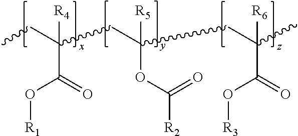

where:
   R₁, R₂, R₃, R₄, R₅, and R₆ are independent radicals represented by the groups mentioned below:
   R₁=CH₃ (methyl), C₂H₅ (ethyl), C₄H₉ (n-butyl), C₄H₉ (iso-butyl), C₄H₉ (tert-butyl), C₅H₁₁ (pentyl), C₆H₁₃ (n-hexyl), C₈H₁₇ (2-ethylhexyl), C₉H₁₉ (3,5,5-trimethylhexyl), C₈H₁₇ (n-octyl), C₈H₁₇ (iso-octyl), C₁₀H₂₁ (n-decyl), C₁₀H₂₁ (iso-decyl), C₁₀H₁₉ (10-undecenyl), C₁₀H₁₉ (tert-butyl-cyclohexyl), C₁₂H₂₅ (n-dodecyl), C₁₈H₃₇ (n-octadecyl), C₁₃H₂₇ (tridecyl), or C₂₂H₄₅ (behenyl),
   R₂═CH₃ (methyl), C₂H₅ (ethyl), C₃H₇ (propyl), C₄H₉ (butyl), (CH₃)₃C (tert-butyl), C₈H₁₇ (octyl), CH₁₉ (nonyl), C₁₁H₂₃ (undecyl), or C₁₇H₃₅ (octadecanyl),
   R₃=C₃H₅₀₂ (2-carboxyethyl), C₄H₇₀₂ (3-carboxypropyl), or C₅H₉₀₂ (4-carboxybutyl),
   R₄ and R₆=H (hydrogen) or CH₃ (methyl),
   R₅=H, CH₃, or CN,
wherein:
   x=is a number set up from 9 to 1449,
   y=is a number set up from 3 to 994,
   z=is a number set up from 5 to 1307,
   “X”, “y”, and “z” are presented in a random sequences, where the number average molecular mass in number (M̅ₙ) of the random acrylic terpolymers are in the range from 1750 to 1 100 000 g·mol⁻¹.

It is important to mention that the M̅ₙ value cannot be higher than the value mentioned above, because longer polymeric chains could form an additional barrier at the emulsified water/crude oil interface and, hence, inhibiting the dehydration process. In addition to this, the range of M̅ₙ value of the random acrylic terpolymer allows treating crude oils in the range from 8 to 40° API. It has been widely described in literature that there is a relationship between the value of the average molecular mass in number of the polymer and the average molecular mass of the crude oil—related to the API gravity—[49]. Therefore: (a) polymers of low M̅ₙ value should be employed for light crude oils, (b) polymers of medium M̅ₙ value should be employed, and (c) polymers of high M̅ₙ value should be employed for heavy and extra-heavy crude oils. Besides this, the composition of the crude oil—SARA fraction—(method for characterizing heavy oils based on fractionation into four solubility classes: saturates, aromatics, resins and asphaltenes)—has an important effect on the molecular mass of the terpolymer to be used. Two crude oils can have the same API gravity, but if their SARA fraction is different, the molecular mass of the employed terpolymer will not be the same.

The alkyl acrylate monomers selected for the synthesis of the random acrylic terpolymers object of the present disclosure described below, by way of example, are from the group consisting of: methyl acrylate, ethyl acrylate, butyl acrylate, pentyl acrylate, isobutyl acrylate, tert-butyl acrylate, hexyl acrylate, 2-ethylhexyl acrylate, 3,5,5-trimethylhexyl acrylate, 4-tert-butylcyclohexyl acrylate, octyl acrylate, isodecyl acrylate, decyl acrylate, lauryl acrylate, tridecyl acrylate, octadecyl acrylate, behenyl acrylate, methyl methacrylate, ethyl methacrylate, butyl methacrylate, pentyl methacrylate, isobutyl methacrylate, tert-butyl methacrylate, hexyl methacrylate, 2-ethylhexyl methacrylate, 4-tert-butylcyclohexyl methacrylate, octyl 3,5,5-trimethylhexyl methacrylate, methacrylate, isodecyl methacrylate, decyl methacrylate, lauryl methacrylate, tridecyl methacrylate, octadecyl methacrylate, or behenyl methacrylate.

On the other hand, the ethylene alkylacetate monomers selected for the synthesis of the random acrylic terpolymers, object of the present disclosure, are from the group consisting of: vinyl acetate, vinyl propanoate, vinyl butyrate, vinyl trimethylacetate, vinyl pentanoate, vinyl laurate, vinyl neononanoate, vinyl decanoate, vinyl octadecanoate, 1-methylvinyl acetate, or 1-cyanovinyl acetate.

In relation to the β-carboxyalkyl acrylate monomers selected for the synthesis of the random acrylic terpolymers object of the present disclosure, are from the group consisting of: β-carboxyethyl acrylate, γ-carboxypropyl acrylate, δ-carboxybutyl acrylate, β-carboxyethyl methacrylate, γ-carboxypropyl methacrylate, or δ-carboxybutyl methacrylate.

In order to induce the destabilization of the emulsified water/crude oil interface, followed by the coalescence process of emulsified water droplets and, finally, the elimination of emulsified water present in crude oils with gravities ranging from 8 to 40° API, the experimental procedure consists of adding an effective amount of solution of the random terpolymer based on alkyl acrylate-ethylene alkylacetate-β-carboxyalkyl acrylate to the crude oil to be assessed; the concentration of the basic in the solution is in the range from 3 to 5000 ppm.

### EXAMPLES

The present disclosure will be described with reference to a specific number of examples, which will be considered only as illustrative and, therefore, not restrictive of the present disclosure.

### Example 1

### Characterization of the Random Terpolymers

Once the random terpolymers based on alkyl acrylate-ethylene alkylacetate-β-carboxyalkyl acrylate were obtained, these were characterized using the following spectroscopic methods:
1.—Size exclusion chromatography (SEC): in an Agilent™ model 1100 size exclusion chromatograph, with a PLgel column and using tetrahydrofuran (THF) as eluent, to calculate the average molecular masses distribution of the acrylic terpolymers, as well as the polydispersity index (/). The calibration of the equipment was carried out using three polystyrene standards from Polymer Laboratories: RED vial, M̅_{w}=5 000 000, 325 000, 21 000, and 1270 g·mol⁻¹; BLUE vial, M̅_{w}=1 950,000, 113 300, 7200, and 580 g·mol⁻¹; GREEN vial, M̅_{w}=696 500, 50 400, 2960, and 162 g·mol⁻¹.
2.—Fourier transform infrared spectroscopy (FTIR): spectra were obtained in a Thermo Nicolet™ AVATAR 330 Fourier transform infrared spectrometer employing the film technique method with the OMNIC™ 7.0 software. 64 scans were employed to acquire the spectrum in the transmission mode with a wavelength range from 400 to 4000 cm-1.
3.—Nuclear magnetic resonance (NMR) of ¹H and ¹³C: in a Bruker™ AVANCE NEO spectrometer, with frequency of 600 MHZ (¹H) and 150 MHZ (¹³C). Approximately 150 mg of dry terpolymer was dissolved in deuterated chloroform (CDCl₃)—dissolvent—, referencing the changes of chemical shift regarding tetramethylsilane (TMS). Pulse sequence for the ¹H and ¹³C nucleus is the implemented in the equipment's software.
4. Thermogravimetric analysis (TGA): thermograms were obtained in a TA instruments TGA 2950 thermogravimetric analyzer. The sample was heated from room temperature to 500 °C, with a heating rate of 5 °C·min⁻¹ and nitrogen flow of 10 °C·min⁻¹.
5. Particle size distributions (D_{z}): the particle size distribution of the polymer latex was obtained in an Anton Paar instrument, Litesizer® 500 particle analyzer. A solution of 5 drops of latex in 2.5 mL of distilled water was prepared; subsequently, the refractive index value was determined using an Anton Paar instrument, Abbemat™ 300 automatic refractometer, value that was used in the Kalliope™ software to determine the particle diameter value.

Tables 4 and 5 displays the weight ratio of the alkyl acrylate (K), ethylene alkylacetate (N), and β-carboxyalkyl acrylate (X) monomers, the latex particle diameter, the average molecular mass in number of the dry terpolymer, and the degradation temperature of the terpolymers based on alkyl acrylate-ethylene alkylacetate-β-carboxyalkyl acrylate of the KNX-2 and KNX-4 series, respectively. Table 4 shows the results for the poli (alkyl acrylate-ethylene alkylacetate-β-carboxyalkyl acrylate) (R₁=n-butyl, R₂=methyl, R₃=β-carboxyethyl, R₄, R₅, and R₆=hydrogen) corresponding to the KNX-2 series, which does not mean any limitation.

TABLE 4
Compositions in wt % of the terpolymers based on alkyl acrylate -
ethylene alkylacetate - β-carboxyalkyl acrylate of the KNX-2
series and the particle diameter (D_{z}) of the latex, as well as
the average molecular mass in number (M̅ₙ) determined by SEC and
the degradation temperature —both of dry polymer—.

| | K, N, and X | | | |
|---|---|---|---|---|
| | monomeric | | | Degradation |
| | weight ratio | D_{z} | M̅ₙ | temperature |
| Terpolymer | (wt %) | (nm) | (g · mol⁻¹) | (°C) |
| KNX-9552 | 90/05/05 | 228 | 23443 | 300 |
| KNX-8112 | 80/10/10 | 217 | 16768 | 304 |
| KNX-7212 | 70/20/10 | 221 | 24395 | 305 |
| KNX-7122 | 70/10/20 | 225 | 15036 | 310 |
| KNX-6312 | 60/30/10 | 209 | 31006 | 312 |
| KNX-6222 | 60/20/20 | 212 | 20807 | 315 |
| KNX-6132 | 60/10/30 | 215 | 16378 | 318 |

Table 5 exhibits the results for the poly(alkyl acrylate ethylene alkylacetate-β-carboxyalkyl acrylate) (R₁=n-butyl, R₂=methyl, R₃=β-carboxyethyl, R₄, R₅, and R₆=hydrogen) corresponding to the KNX-4 series, which does not mean any limitation.

TABLE 5
Compositions in wt % of the terpolymers based on alkyl acrylate -
ethylene alkylacetate - β-carboxyalkyl acrylate of the KNX-4
series and the particle diameter (D_{z}) of the latex, as well as
the average molecular mass in number (M̅ₙ) determined by SEC and
the degradation temperature —both of dry polymer—.

| | K, N, and X | | | |
|---|---|---|---|---|
| | monomeric | | | Degradation |
| | weight ratio | D_{z} | M̅ₙ | temperature |
| Terpolymer | (wt %) | (nm) | (g · mol⁻¹) | (°C) |
| KNX-9554 | 90/05/05 | 205 | 10382 | 298 |
| KNX-8114 | 80/10/10 | 209 | 8729 | 303 |
| KNX-7214 | 70/20/10 | 202 | 9911 | 306 |
| KNX-7124 | 70/10/20 | 206 | 8493 | 310 |
| KNX6314 | 60/30/10 | 211 | 7247 | 314 |
| KNX-6224 | 60/20/20 | 202 | 8217 | 317 |
| KNX-6134 | 60/10/30 | 204 | 7946 | 320 |

The following examples are presented to illustrate the spectroscopic characteristics of the terpolymers based on alkyl acrylate-ethylene alkylacetate-β-carboxyalkyl acrylate employed as dehydrating agents of crude oils with gravities ranging from 8 to 40° API. These examples should not be considered as limiting what is claimed here.

### Example 2

### KNX-2 and KNX-4 Series

Random terpolymers based on alkyl acrylate-ethylene alkylacetate-β-carboxyalkyl acrylate:

IR. ν cm⁻¹: 3446, 2962, 2931, 2873, 1728, 1450, 1371, 1234, 1147, 1110, 1065, 1024, and 943.

NMR ¹H δ (ppm): 4.39, 4.05, 3.65, 2.70, 2.68, 2.47, 2.35, 2.29, 1.98, 1.91, 1.60, 1.28, 1.26, 0.94, 0.89, 0.88, and 0.87.

NMR ¹³C δ (ppm): 174.60, 174.44, 170.14, 64.56, 64.53, 64.36, 60.08, 41.49, 41.26, 40.38, 40.25, 39.68, 39.45, 38.63, 37.34, 35.39, 35.22, 34.82, 32.58, 32.46, 30.63, 30.58, 30.54, 29.62, 29.52, 29.37, 19.12, 14.10, 14.06, and 13.71.

### Example 3

Assessment of the Random Terpolymers Based on Alkyl Acrylate-Ethylene Alkylacetate-β-Carboxyalkyl Acrylate as Dehydrating Agents of Crude Oils with Gravities Ranging from 8 to 40° API.

In order to assess the water removal efficiency of the random terpolymers based on alkyl acrylate-ethylene alkylacetate-β-carboxyalkyl acrylate, solutions of each dry terpolymer were prepared—drying process at a temperature from 80 to 120 °C—, in which the concentration of the dry terpolymer is between 0.50 and 50.00 wt %. Solvents such as dichloromethane, methanol, ethanol, isopropanol, 2-butoxyethanol, 2-butoxyethane acetate, chloroform, benzene, toluene, xylene, turbosine, and naphtha were used for their preparation. These were employed individually or in the form of mixtures, thus, small volumes of the solution were added, with the purpose of eliminating possible effects related to the solvent, which could influence the performance of random acrylic terpolymers as demulsifying agents. The KNX random acrylic terpolymers were assessed in concentrations ranging from 3 to 5000 ppm, together with four commercial products widely used in the oil industry—FD-1, FD-2, FD-3, and FD-4 (TRETOLITE™ which is widely used at the laboratory level in field evaluations)—and the TOMAC ionic liquid (only employed at the laboratory level). Regarding the FD-1 commercial product, this is a formulation consisting of four basics based on polyethers of different weight compositions of propylene oxide (PO, 60 wt %≥)/ethylene oxide (EO, ≥40 wt %) and different average molecular mass in number. The properties of the PEO-PPO-PEO triblock basics that make up the FD-1 commercial formulation are present in Table 6. The point that the formulation contains at least three POE-POP-POE triblock basics of different M̅ₙ value is to confer to the formulation the three required properties in a demulsifying agent: breaker, coalescer and clarifier. About the FD-2 commercial formulation, this is made up for ethoxylated resin basics—with different ethoxylation degree and, therefore, different M̅ₙ value; whereas the FD-3 commercial formulation is composed of ethoxylated phenol nonyl basics—with different ethoxylation degrees and, hence, different M̅ₙ value—. Regarding the FD-4 demulsifying agent—TRETOLITE™, known in the industrial field as F-46, which is mainly used to determine the total water content present in crude oil using the ASTM D-4007 method “Standard test method for water and sediment in crude oil by the centrifuge method (laboratory procedure)”—, it consists of an oxyalkylated arylsulfonate ethylene formaldehyde resin, also containing alcohols such as isopropanol and methanol, as well as alkali metal halides—NaCl or KCl—. Finally, the TOMAC ionic liquid (tri-n-octyl methyl ammonium chloride), which presents a good performance in the dehydration of crude oils, is exclusively used in laboratory assessment due to its high production cost—a similar situation applies to the FD-46 commercial formulation—.

TABLE 6
Components of the FD-1 commercial formulation, including PO/EO
composition in weight and average molecular mass in number (M̅ₙ).
FD-1 formulation

| | PO/EO | |
|---|---|---|
| | composition | M̅ₙ |
| Labeled | (wt %) | (g · mol⁻¹) |
| TP 89 | 90/10 | 7750 |
| TP 03 | 70/30 | 5330 |
| TP 14 | 60/40 | 3050 |
| TP 71 | 90/10 | 1400 |

For the assessment of the performance of the random terpolymers based on alkyl acrylate-ethylene alkylacetate-β-carboxyalkyl acrylate as demulsifying agents, as well as the commercial products, the following methodology was used: firstly, in 150 mL graduated oblong bottles, provided with insert and cap, the required aliquot of the solution of the alkyl acrylate-ethylene alkylacetate-β-carboxyalkyl acrylate was added, as well as the aliquot of the TOMAC ionic liquid and the FD-1, FD-2, FD-3, and F-46 commercial products. An additional bottle without a demulsifying agent is considered and labeled as a control sample. The bottles were subsequently dosed with crude oil up to the 100 mL mark. It is important to mention that the bottle was not shaken after dosing the crude oil—a common industrial procedure to “homogenize” the demulsifying agent in the crude oil—, in order to avoid any alteration of the original emulsion (manual shaking, even for short periods of up to one minute, significantly affects the water droplet size—increasing the droplet diameter value—). Afterwards, the amount of removed water for each bottle was measured (considering as time zero), and these were placed in a temperature-controlled thermal bath, using an assessment range from 25 to 90 °C. The amount of removed water was measured each 5 min during the first hour; subsequently, each half hour during the second hour and, finally, each hour during the resting time of the assessment (5 h). Random acrylic terpolymers of the present disclosure and commercial products were assessed at different concentrations ranging between 3 and 5000 ppm.

Table 7 lists the physicochemical characterization of the employed crude oils in the assessment of the random terpolymers based on alkyl acrylate-ethylene alkylacetate-β-carboxyalkyl acrylate as dehydrating agents of crude oils of different API gravity—from 8 to 40° API—. Also, in this Table 7, the obtained results from the SARA analysis are included in four classes: saturates (up to ~36 wt %), aromatic (up to ~35 wt %), resins (up to ~20 wt %), and asphaltenes (up to ~20 wt %).

TABLE 7
Characteristics and physicochemical properties of
the employed crude oils to assess the random acrylic
terpolymers object of the present disclosure.

| Property | PR-1 | PR-2 | PR-3 |
|---|---|---|---|
| Gravity (°API) | 13.30 | 21.60 | 28.70 |
| Salt content (lb · mbb⁻¹) | 2825.03 | 124.94 | 3.02 |
| Paraffin content (wt %) | 6.05 | 6.58 | 6.77 |
| Pouring temperature (°C) | −42.00 | −36.00 | −45.00 |
| Water by distillation (vol %) | 39.00 | 49.00 | 0.00 |
| Water and sediments (vol %) | 40.00 | 50.00 | 0.00 |
| Cinematic viscosity | 63.60 | 45.52 | 10.23 |
| (mm² · s⁻¹) @ 40 °C | | | |
| M̅ₙ by cryoscopy (g · mol⁻¹) | 406.00 | 241.00 | 201.00 |
| Saturates (wt %) | 35.95 | 3137 | 0.15 |
| Aromatics (wt %) | 34.37 | 35.47 | 0.04 |
| Resins (wt %) | 20.10 | 29.32 | 97.32 |
| Asphaltenes (wt %) | 9.54 | 3.80 | 2.47 |

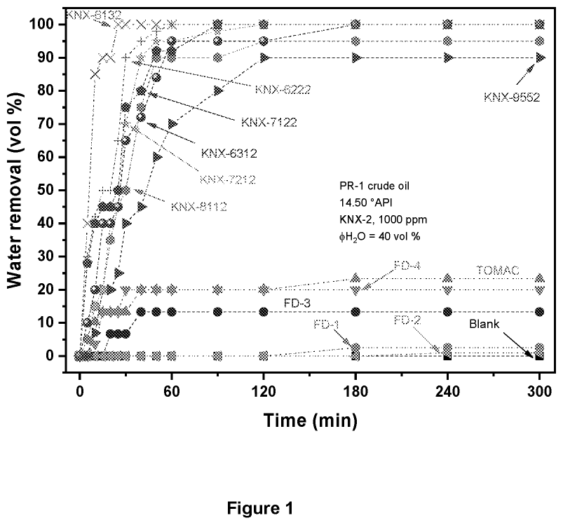

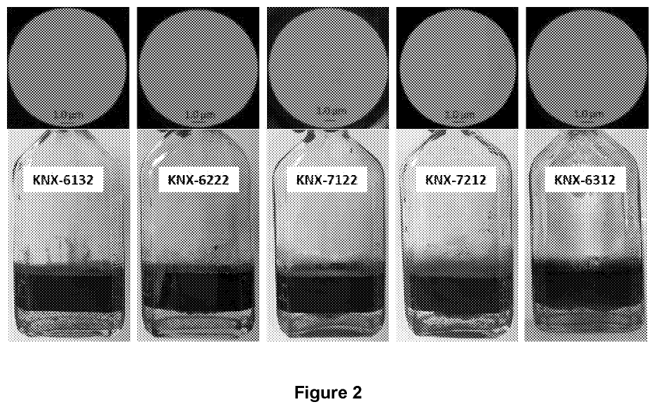

By way of example, but not limited to, FIGS. 1, 3, 5, 7, and 9 exhibit the results of emulsified-water removal efficiency as function of time; while FIGS. 2, 4, 6, 8, and 10 show the optical micrographs of the treated crude oil with a demulsifying agent—acrylic terpolymer and/or commercial product—, as well as the images of the bottles, where the removed water/crude oil interface and the clarification of the removed water can be observed.

FIG. 1 presents the performance of the random terpolymers based on alkyl acrylate-ethylene alkylacetate-β-carboxyalkyl acrylate of the KNX-2 series in the PR-1 crude oil (14.50° API), dosage at 1000 ppm. At 5 min of the assessment, the KNX-6132 (40 vol % of removed water), KXN-6222 (30 vol %), KNX-7122 (28 vol %), KNX-6312 (10 vol %), KNX-7212 (10 vol %), and KNX-8112 (5 vol %) random acrylic terpolymers managed to destabilize the water/crude oil interface; whereas the TOMAC (10 vol %) and the FD-4 (4 vol %) also induced the destabilization of the W/O interface.

In this way, specifically the KXN-6132 (M̅ₙ=16378 g·mol⁻¹) terpolymer showed a better performance as breaker of the water/crude oil emulsion than the commercial products at 5 min of the assessment, and subsequently, an excellent performance as a coalescer, reaching the total removal of emulsified water, 100 vol %, at 25 min. The KNX-6222 (M̅ₙ=20807 g·mol⁻¹) terpolymer also removed 100% of the emulsified water, but at 60 min. The KNX-7122 (M̅ₙ=15036 g·mol⁻¹) and KNX-7212 (M̅ₙ=24395 g·mol⁻¹) terpolymers exhibited the same performance as the two previous terpolymers, however, at a longer time—90 and 120 min de la assessment, respectively—; while the KNX-6312 (M̅ₙ=31006 g·mol⁻¹) terpolymer achieved this performance up to 180 min—lower coalescence rate—. The KNX-8112 (M̅ₙ=16768 g·mol⁻¹) and KNX-9552 (M̅ₙ=23443 g·mol⁻¹) terpolymers displayed a good performance in the water removal, withdrawing 95 vol % and 90 vol %, respectively. Regarding the KNX-6132 and KNX-6222 terpolymers, by increasing the weight content of the β-carboxyalkyl acrylate monomer—monomer with high negative hydration energy value—, there was an increase in the performance as demulsifying agent—breaker and coalescer—. About the TOMAC ionic liquid, this barely removed 23 vol % of the emulsified water. In the case of the FD-3 and FD-4 commercial products, these showed an incipient performance, barely eliminating 13 and 20 vol %, respectively, while the FD-1 and FD-2 products had almost no performance (<3 vol %).

FIG. 2 presents the optical micrographs of the PR-1 treated crude oil (14.50° API) with the KNX-6132, KNX-622, KNX-6312, KNX-7212, and KNX-7122 terpolymers, where no emulsified water is appreciated; however, the presence of organic agglomerates—mainly asphaltenes—can be observed. In the case of the TOMAC ionic liquid, a monodisperse emulsified system is exhibited, with droplet diameters mainly of 0.98 μm. The micrographs of the treated crude oil with the FD-4 commercial formulation displays a polydisperse emulsified system, with droplet diameter no greater than 1.00 μm.

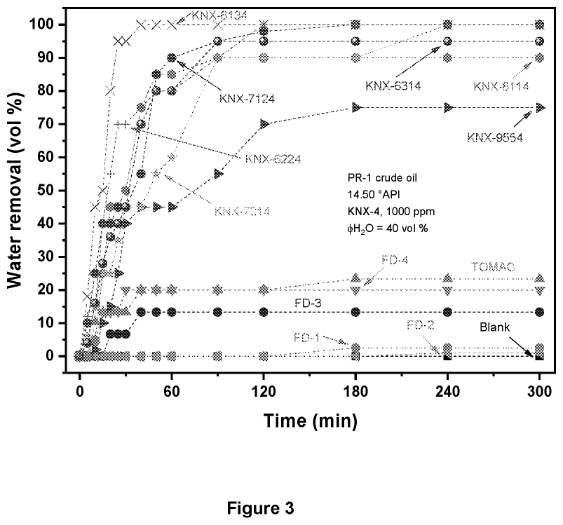

FIG. 3 shows the performance of the random terpolymers based on alkyl acrylate-ethylene alkylacetate-β-carboxyalkyl acrylate of the KNX-4 series in the PR-1 crude oil (14.50° API), dosage at 1000 ppm. In this case, at 5 min of the assessment, the KNX-6134 (18 vol %), KNX-6224 (12 vol %), KNX-7124 (10 vol %), KNX-7214 (6 vol %), and KNX-6314 (4 vol %) acrylic terpolymer managed to destabilize the W/O interface and to induce the coalescence of the droplets. Thus, a ratio of 30 wt % of the β-carboxyalkyl acrylate—monomer with higher negative hydration energy value—and a lower average molecular mass in number (M̅ₙ=7946 g·mol⁻¹)—shorter polymeric chain length—efficiently promotes the destabilization of the asphaltene-resin agglomerates, compared to the KNX-6224 (M̅ₙ=8217 g·mol⁻¹), KNX-7124 (M̅ₙ=8493 g·mol⁻¹), and KNX-7214 (M̅ₙ=9911 g·mol⁻¹) terpolymers. Regarding the final performance, the KNX-6314 terpolymer reached the maximum efficiency, 100 vol %, at 40 min, while the KNX-6224 terpolymer achieved this performance at 120 min of the assessment. For the KNX-7124 and KNX-7214 random acrylic terpolymers, theses also achieved to remove 100 vol % of the emulsified water in a longer time, 180 and 240 min of the assessment, respectively. In the case of the KNX-6314 and KNX-8114 terpolymers, these displayed a good performance in the emulsified water removal, reaching a maximum efficiency of 95 and 90 vol %, respectively. Finally, KNX-9554 presented the lowest performance, reaching a final removal of 75 vol %.

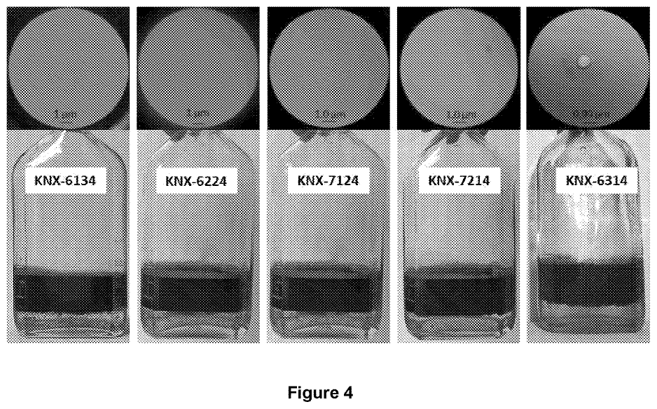

FIG. 4 displays the optical micrographs of the PR-1 treated crude oil (14.50° API) with the KNX-6134, KNX-6224, KNX-7124, and KNX-7214 random acrylic terpolymers, where the absence of emulsified water is notorious, demonstrating the excellent performance of these products in the water removal present in the PR-1 crude oil. In the case of the micrograph of the treated crude oil with the KNX-6314 random acrylic terpolymer, a water droplet with a diameter of approximately 1.0 μm can be observed. In addition to good performance as breakers and coalescers, the random acrylic terpolymers based on alkyl acrylate-ethylene alkylacetate-β-carboxyalkyl acrylate of the KNX-4 series present an excellent performance in the clarification of the removed water.

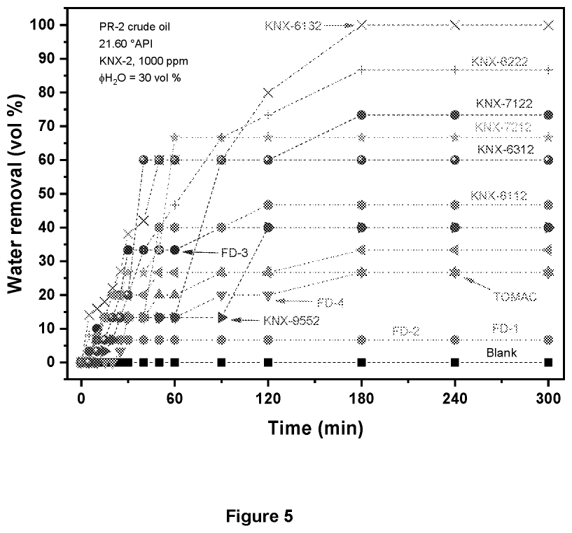

FIG. 5 displays the performance of the random terpolymers based on alkyl acrylate-ethylene alkylacetate-β-carboxyalkyl acrylate of the KNX-2 series in the PR-2 crude oil (21.60° API), dosage at 1000 ppm. At 5 min of the assessment, the KNX-6132, KNX-6222, and KNX-7122 random acrylic terpolymers managed to destabilize the asphaltenes and resins films, promoting the breaking of the emulsion and removing 14, 8, and 3 vol %, respectively. The KNX-6132 terpolymer displayed an excellent performance for the emulsified water removal, being the only capable of completely eliminating the emulsified water at 180 min of the assessment. With slightly lower efficiency, the KNX-6222 terpolymer achieved a maximum removal of 87 vol % of the water present in the crude oil, while the most efficient terpolymer. In the case of the KNX-7122, KNX-7212, and KNX-6312 terpolymers, these reached a water removal efficiency of 73, 67, and 60 vol %, respectively. The KNX-8112 and KNX-9552 terpolymers only eliminated 47 and 40 vol % of the emulsified water, respectively. On the other hand, the TOMAC ionic liquid induced the destabilization of the emulsion up to 10 min of the assessment, removing 7 vol % of water and reaching a maximum efficiency of 23 vol %. In the case of the FD-1, FD-2, and FD-3 commercial formulations, these also managed to destabilize the emulsion present at 10 min, eliminating 3, 8, and 10 vol %, respectively. The FD-4 formulation exhibited the lowest performance as breaker, achieving this objective of destabilization of the emulsion up to 25 min, but only with 3 vol % of the emulsified water. At the end of the assessment, FD-3 presents the best performance of the four, removing scarcely 40 vol %, whereas FD-1, FD-2, and FD-4 barely eliminated 7, 33, and 27 vol %, respectively.

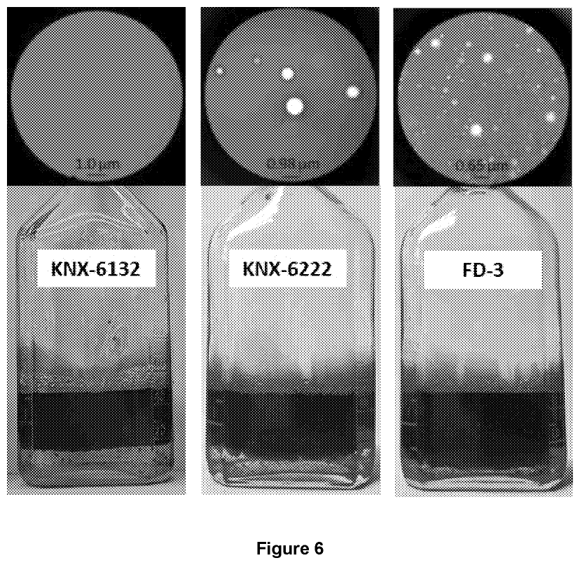

FIG. 6 displayed the optical micrographs of the PR-2 treated crude oil (21.60° API) with the KNX-6132 and KNX-6222 random acrylic terpolymers based on alkyl acrylate-ethylene alkylacetate-β-carboxyalkyl acrylate, as well as the FD-3 commercial formulation. In the case of the first acrylic terpolymer, KNX-6132, emulsified water droplets are not observed, confirming its excellent performance. By another way, the micrograph of the KNX-6222 terpolymer shows the presence of emulsified water, specifically three water droplets with an approximately diameter of 0.98 μm and two droplets with a dimeter of approximately 0.50 μm. The treated crude oil with the FD-3 commercial formulation shows a high emulsified water content, presenting an emulsified system with high polydispersity, with a droplet diameter from 0.10 to 0.60 μm. On the other hand, the clarification of the removed water with the KNX-6132 and KNX-6222 random acrylic terpolymers is significantly superior to that obtained with the FD-3 commercial formulation. Furthermore, a well-defined interface is observed with the treated crude oil with the KNX-6132 acrylic terpolymer, while the interface with the FD-3 commercial formulation is poorly defined.

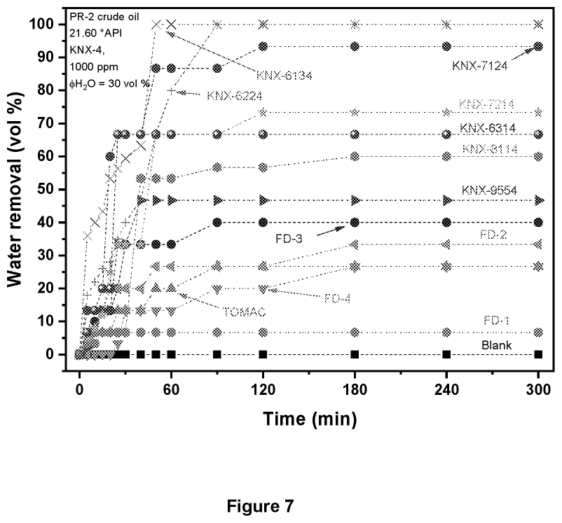

FIG. 7 exhibits the performance of the random terpolymers based on alkyl acrylate-ethylene alkylacetate-β-carboxyalkyl acrylate of the KNX-2 series in the PR-2 crude oil (21.60° API), dosage at 1000 ppm. At 5 min of the assessment, all the acrylic terpolymers induced the destabilization of the asphaltene-resin agglomerates, being the KNX-6134, KNX-6224, and KNX-7124 terpolymers which removed the higher amount of water 36, 18 and 13 vol %, respectively. The first two products displayed excellent performance as coalescers, removing 100 vol % of emulsified water at 50 and 90 min, respectively. Once again, the effect of the weight ratio of the β-carboxyalkyl acrylate present in the KNX-6134 acrylic terpolymer, as well as its M̅ₙ value on the destabilization of the asphaltene-resin agglomerates surrounding the emulsified water droplets, is noticeable. In the case of the KNX-7124 terpolymer, a maximum emulsified water removal efficiency of 93% was reached after 120 min of the assessment. The remaining KNX-7214, KNX-6314, KNX-8114, and KNX-9554 acrylic terpolymers removed 73, 67, 60, and 47 vol % of the emulsified water, respectively.

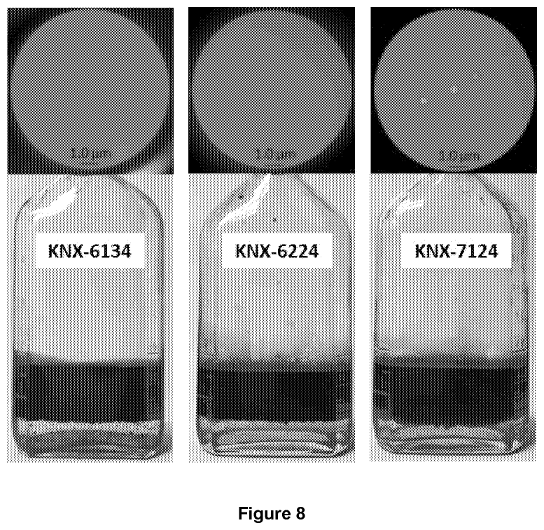

FIG. 8 shows the optical micrographs of the PR-2 treated crude oil (21.60° API) with the KNX-6134, KNX-6224, and KNX-7124 random acrylic terpolymers. For the KNX-6134 and KNX-6224 terpolymers, the absence of emulsified water droplets is appreciable, thus corroborating the excellent performance of these two acrylic terpolymers. Regarding the optical micrograph when the KNX-7124 acrylic terpolymer is employed, the presence of three water droplets with a droplet water diameter of 0.33 μm is observed. About the clarification of the removed water, the three acrylic terpolymers present an excellent performance, with a good definition of the removed water/crude oil interface.

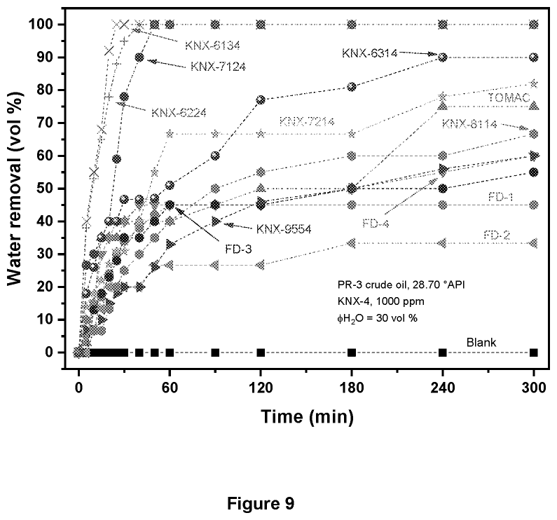

FIG. 9 presents the performance of the random terpolymers based on alkyl acrylate-ethylene alkylacetate-β-carboxyalkyl acrylate of the KNX-4 series in the PR-3 crude oil (28.70° API), dosage at 1000 ppm. At 5 min of the assessment, all the acrylic terpolymers induced the destabilization of the asphaltene and resin films, removing KNX-6134 up to 40 vol %, KNX-6224 up to 38 vol %, KNX-7124 up to 27 vol %, KNX-6314 up to 18 vol %, KNX-7214 up to 14 vol %, KNX-8114 up to 10 vol %, and KNX-9554 up to 7 vol %. Once again the KNX-6134 terpolymer displayed the best performance in the coalescence of the emulsified water droplets, completely removing this, 100 vol %, at 25 min of the assessment, following by KNX-6224 at 40 min and, finally, KNX-7124 at 50 min. Regarding the KNX-6314 and KNX-7214 terpolymers, these achieved to remove 90 and 82 vol % of the emulsified water, respectively. The KNX-8114—67 vol %—and KNX-9554—60 vol %—terpolymers showed lower performance. Among the commercial products, the TOMAC ionic liquid and the FD-4 commercial formulation achieved the destabilization of the water/crude oil interface at 5 min of the assessment but scarcely removing 3 and 5 vol %, respectively. TOMAC showed the best performance among these products, reaching a final removal of 75 vol %, followed by the FD-4 commercial formulation with 60 vol %. For the case of the FD-1, FD-2, and FD-3 commercial formulations, these displayed a low performance, removing 45, 33, and 55 vol %, respectively.

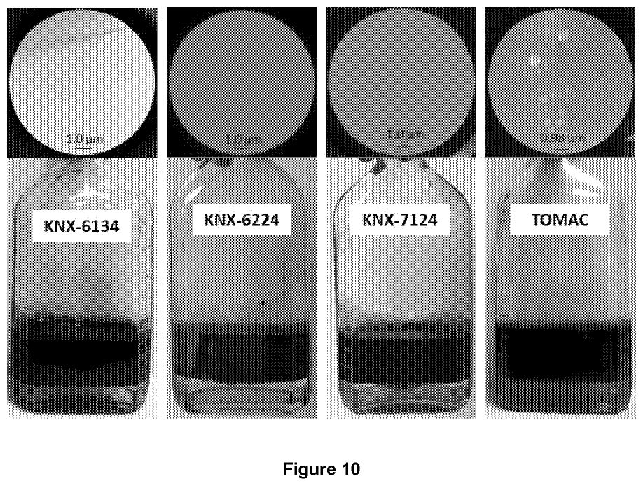

FIG. 10 shows the optical micrographs of the PR-3 treated crude oil (28.70° API) with the KNX-6134, KNX-6224, and KNX-7124 random acrylic terpolymers based on alkyl acrylate-ethylene alkylacetate-β-carboxyalkyl acrylate, as well as the TOMAC ionic liquid. For the case of the random acrylic terpolymers, there is not observed the presence of emulsified water droplets, thus corroborating the total removal of this. About the treated crude oil with TOMAC, water droplets with diameter approximately of 0.50 μm are observed, although a minimal amount of water droplets with a diameter close to 0.98 μm can be also seen. Finally, about the clarification of the removed water, the excellent performance obtained by the random acrylic terpolymers is noticeable, while the TOMAC exhibits a low performance for the clarification of the removed water.

1. A random terpolymer comprising alkyl acrylate-ethylene alkylacetate-β-carboxyalkyl acrylate and useful as a demulsifying agent of crude oil with gravities from 8 to 40° API with different water content and composition in the SARA fractions up to 36 wt % of saturates, up to 35 wt % of aromatics, up to 20 wt % of resins, and up to 20 wt % of asphaltenes, wherein the random terpolymer comprises a structural Formula (1) with molecular masses between 1750 and 1100000 g·mol⁻¹: 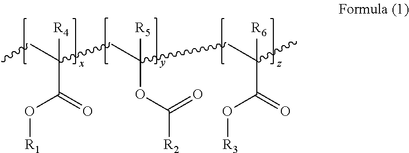
where:
R₁, R₂, R₃, R₄, R₅, and R₆ are independent radicals represented by the groups mentioned below:
R₁=CH₃ (methyl), C₂H₅ (ethyl), C₄H₉ (n-butyl), C₄H₉ (isobutyl), C₄H₉ (tert-butyl), C₅H₁₁ (pentyl), C₆H₁₃ (n-hexyl), C₈H₁₇ (2-ethylhexyl), C₉H₁₉ (3,5,5-trimethylhexyl), C₈H₁₇ (n-octyl), C₈H₁₇ (isooctyl), C₁₀H₂₁ (n-decyl), C₁₀H₂₁ (isodecyl), C₁₀H₁₉ (10-undecenyl), C₁₀H₁₉ (tert-butyl-cyclohexyl), C₁₂H₂₅ (n-dodecyl), C₁₈H₃₇ (n-octadecyl), C₁₃H₂₇ (tridecyl), or C₂₂H₄₅ (behenyl),
R₂═CH₃ (methyl), C₂H₅ (ethyl), C₃H₇ (propyl), C₄H₉ (butyl), (CH₃)₃C (tert-butyl), C₈H₁₇ (octyl), C₉H₁₉ (nonyl), C₁₁H₂₃ (undecyl), or C₁₇H₃₅ (octadecanyl),
R₃=C₃H₅₀₂ (2-carboxyethyl), C₄H₇₀₂ (3-carboxypropyl), or C₅H₉₀₂ (4-carboxybutyl),
R₄ and R₆=H (hydrogen) or CH₃ (methyl),
R₅=H, CH₃, or CN,
wherein:
x=is a number set up from 9 to 1449,
y=is a number set up from 3 to 994,
z=is a number set up from 5 to 1307,
“x”, “y” and “z” are presented in a random sequence.

2. The random terpolymer according to claim 1, wherein the alkyl acrylate monomer is selected from the group consisting of: methyl acrylate, ethyl acrylate, butyl acrylate, pentyl acrylate, isobutyl acrylate, tert-butyl acrylate, hexyl acrylate, 2-ethylhexyl acrylate, 3,5,5-trimethylhexyl acrylate, 4-tert-butylcyclohexyl acrylate, octyl acrylate, isodecyl acrylate, decyl acrylate, lauryl acrylate, tridecyl acrylate, octadecyl acrylate, behenyl acrylate, methyl methacrylate, ethyl methacrylate, butyl methacrylate, pentyl methacrylate, isobutyl methacrylate, tert-butyl methacrylate, hexyl methacrylate, 2-ethylhexyl methacrylate, 3,5,5-trimethylhexyl methacrylate, 4-tert-butylcyclohexyl methacrylate, octyl methacrylate, isodecyl methacrylate, decyl methacrylate, lauryl methacrylate, tridecyl methacrylate, octadecyl methacrylate and behenyl methacrylate.

3. The random terpolymer according to claim 1, wherein the ethylene alkyl acetate monomer is selected from the group consisting of: vinyl acetate, vinyl propanoate, vinyl butyrate, vinyl trimethylacetate, vinyl pentanoate, vinyl laurate, vinyl neononanoate, vinyl decanoate, vinyl octadecanoate, 1-methylvinyl acetate, and 1-cyanovinyl acetate.

4. The random terpolymer according to claim 1, wherein the carboxyalkyl acrylate monomer is selected from the group consisting of: β-carboxyethyl acrylate, γ-carboxypropyl acrylate, δ-carboxybutyl acrylate, β-carboxyethyl methacrylate, γ-carboxypropyl methacrylate, and δ-carboxybutyl methacrylate.

5. The random terpolymer according to claim 1, wherein the ratio of the alkyl acrylate monomer is between 51.00 and 92.00 wt %, the ethylene alkylacetate monomer is in a compositional range from 3.00 to 35.00 wt %, and the β-carboxyalkyl acrylate monomer is in a range between 5.00 and 46.00 wt %.

6. A formulation of a crude oil dehydrating agent, wherein the formulation comprises one or more random terpolymers according to claim 1 formulated as dry random terpolymers dissolved in a dissolvent selected from the group consisting of: dichloromethane, methanol, ethanol, isopropanol, 2-butoxyethanol, 2-butoxyethane acetate, chloroform, benzene and its derivatives, toluene, xylene, turbosine, and naphtha, individually or in mixtures thereof.

7. The formulation according to claim 6, wherein the concentration of the formulation of the random terpolymers is from 0.50 to 50.00 wt %.

8. The formulation according to claim 6, wherein the formulation of the dissolved random terpolymers in a dissolvent is dosed to crude oil at a concentration in a range from 3 to 5000 ppm.

9. A method of synthesizing one or more random terpolymer having a structural Formula (1) according to claim 1 by semi-continuous emulsion polymerization.

10. The method according to claim 9, wherein the synthesis is performed under starved-monomeric feed conditions.

11. The method according to claim 9, wherein the synthesis is performed under conditions effective to ensure high randomness in the random terpolymer.

12. The method according to claim 9, wherein alkyl acrylate monomer of the random terpolymer is selected from the group consisting of: methyl acrylate, ethyl acrylate, butyl acrylate, pentyl acrylate, isobutyl acrylate, tert-butyl acrylate, hexyl acrylate, 2-ethylhexyl acrylate, 3,5,5-trimethylhexyl acrylate, 4-tert-butylcyclohexyl acrylate, octyl acrylate, isodecyl acrylate, decyl acrylate, lauryl acrylate, tridecyl acrylate, octadecyl acrylate, behenyl acrylate, methyl methacrylate, ethyl methacrylate, butyl methacrylate, pentyl methacrylate, isobutyl methacrylate, tert-butyl methacrylate, hexyl methacrylate, 2-ethylhexyl methacrylate, 3,5,5-trimethylhexyl methacrylate, 4-tert-butylcyclohexyl methacrylate, octyl methacrylate, isodecyl methacrylate, decyl methacrylate, lauryl methacrylate, tridecyl methacrylate, octadecyl methacrylate, and behenyl methacrylate.

13. The method according to claim 9, wherein the ethylene alkyl acetate monomer of the random terpolymer is selected from the group consisting of: vinyl acetate, vinyl propanoate, vinyl butyrate, vinyl trimethylacetate, vinyl pentanoate, vinyl laurate, vinyl neononanoate, vinyl decanoate, vinyl octadecanoate, 1-methylvinyl acetate, and 1-cyanovinyl acetate.

14. The method according to claim 9, wherein the carboxyalkyl acrylate monomer of the random terpolymer is selected from the group consisting of: β-carboxyethyl acrylate, γ-carboxypropyl acrylate, δ-carboxybutyl acrylate, β-carboxyethyl methacrylate, γ-carboxypropyl methacrylate, and δ-carboxybutyl methacrylate.

15. The method according to claim 9, wherein the ratio of the alkyl acrylate monomer is between 51.00 and 92.00 wt %, the ethylene alkylacetate monomer is in a compositional range from 3.00 to 35.00 wt %, and the β-carboxyalkyl acrylate monomer is in a range between 5.00 and 46.00 wt %.

16. A method of using a random terpolymer according to claim 1 as a demulsifying agent of crude oil, the method comprising treating the crude oil with one or more of the random terpolymers.

17. The method according to claim 16, wherein the random terpolymers are used as demulsifying agents of crude oil for removal of simple emulsions of the water-in-crude oil (W/O) type and/or complex emulsions of the crude oil-in-water-in-crude oil (O/W/O) type.

18. The method according to claim 16, wherein the random terpolymers are formulated as dry random terpolymers dissolved in a dissolvent selected from the group consisting of: dichloromethane, methanol, ethanol, isopropanol, 2-butoxyethanol, 2-butoxyethane acetate, chloroform, benzene and its derivatives, toluene, xylene, turbosine, and naphtha, individually or in mixtures thereof.

19. The method according to claim 18, wherein the concentration of the formulation of the random terpolymers is from 0.50 to 50.00 wt %.

20. The method according to claim 18, wherein the formulation of the dissolved random terpolymers in a dissolvent is dosed to crude oil at a concentration in a range from 3 to 5000 ppm.
